(19) United States
(12) Patent Application Publication
(10) Pub. No.: US 2013/0122253 A1
(43) Pub. Date: May 16, 2013

(54) CURABLE RESIN COMPOSITION FOR HARD COAT LAYER AND HARD COAT FILM

(71) Applicant: DAI NIPPON PRINTING CO., LTD., Tokyo (JP)

(72) Inventors: Toshio YOSHIHARA, Shinjuku-ku (JP); Emi SHIMANO, Shinjuku-ku (JP); Tomoyuki HORIO, Shinjuku-ku (JP); Yusuke HAYASHI, Shinjuku-ku (JP)

(73) Assignee: DAI NIPPON PRINTING CO., LTD., Tokyo (JP)

(21) Appl. No.: 13/727,864

(22) Filed: Dec. 27, 2012

Related U.S. Application Data
(63) Continuation of application No. 12/289,508, filed on Oct. 29, 2008.

(30) Foreign Application Priority Data
Oct. 30, 2007 (JP) 2007-281483
Oct. 22, 2008 (JP) 2008-271631

(51) Int. Cl. C09D 5/00

(52) U.S. Cl. CPC C09D 5/00
USPC 428/147; 428/143; 428/221; 428/339; 428/323; 428/329; 428/331; 428/327; 428/149; 428/148

(57) ABSTRACT

The invention provides a hard coat film with transparency and mar-proofness, obtained by coating, drying and curing on a transparent base film a curable resin composition for a hard coat layer comprising (1) reactive inorganic fine particles A, (2) hydrophilic fine particles B and (3) a curable reactive matrix containing a binder component C that has a reactive functional group c with crosslinking reactivity for the reactive inorganic fine particles A, wherein the content of the hydrophilic fine particles B is 0.1-5.0 wt % with respect to the total solid content, and desired irregularities are formed in the hard coat layer surface, preferably with raised sections having heights of from 3 nm to 50 nm, and spacings between the raised sections of 50 nm-5 μm.

### BACKGROUND OF THE INVENTION

1. Field of the Invention

The present invention relates to a curable resin composition for formation of hard coat layers in hard coat films, which are used to protect the surfaces of displays and the like, as well as to a hard coat film comprising a hard coat layer obtained using the curable resin composition.

2. Related Background Art

The image display surfaces of image display devices such as liquid crystal displays, CRT displays, projection displays, plasma displays, electroluminescence displays and the like must exhibit mar-proofness so that they are not damaged during handling. Improved mar-proofness of image display surfaces in image display devices is commonly achieved using hard coat films comprising a base film provided with a hard coat (HC) layer, or hard coat films further imparted with optical functions such as anti-reflection or anti-glare properties (optical laminates).

When numerous irregularities are present on the surface of the hard coat layer, the raised sections can become caught or subjected to excessive pressure when the hard coat layer comes into contact with hard objects, thus potentially causing microdamage. In order to improve the mar-proofness of the hard coat layer surface, therefore, it is necessary for the hard coat layer surface to be smoothed.

Particularly when the hard coat layer is the cured product of a binder component and surface-hydrophobized reactive inorganic fine particles with a particle size of 80 nm or smaller, the surface is smoothed as the reactive inorganic fine particles become evenly dispersed in the binder component, thus resulting in a hard coat film with sufficient film strength.

However, if a hard coat film with high surface smoothness is continuously taken up into a continuous tape for use as a long roll, the surface of the hard coat layer of the hard coat film contacts and sticks to the surface of the base film side of the hard coat film, similarly to when mirror surfaces are compression fitted. The strength of sticking is different at the peripheral section and at the center section of the roll.

In the manufacture of products employing hard coat films, therefore, it is difficult to control the hard coat film feed rate, and tearing of the hard coat film is a problem during release of the mutually stuck hard coat film surfaces.

One means for preventing such contact sticking between mirror surfaces involves providing one or both sides of the mirror surfaces to be stuck with microprotrusions, at a suitable distribution density so that the smoothness of the mirror surface is not impaired.

Patent document 1 describes including scaly and irregular strips of inorganic fine particles in a curable resin composition for a hard coat layer and forming a hard coat layer using the resin composition, and microprotrusions can possibly be formed in this way since it causes the surface of the hard coat layer to be partly pressed upward by the inorganic fine particles.

However, when scaly and irregular strips of inorganic fine particles are included in the curable resin composition for a hard coat layer, the hard coat layer comprising the resin composition has reduced transparency due to increased scattering within the layer.

Patent document 2 describes an anti-blocking curable resin composition which is a composition comprising a first component composed of a resin and a second component composed of a monomer or oligomer, and which upon coating forms fine irregularities by phase separation and deposition of the resin of the first component; however, using such a composition limits the types of materials that can be used since the difference in SP values of both components is utilized, while it is often difficult to exhibit sufficient hard coat properties and the effect is often unstable, being affected by the drying temperature conditions during film formation.

Also, addition of a compound with sticking resistance, as described in Patent documents 3-5, results in high surface flatness, while virtually no effect is obtained under strong pressure.

When using crosslinked polymer particles having polysiloxane or a fluorine-containing polymer on the particle surfaces, as described in Patent document 6 or Patent document 7, it becomes difficult to form irregularities on the surfaces in a hydrophobic binder component, and therefore a sufficient effect is not exhibited.
[Patent document 1] Japanese Unexamined Patent Publication No. 2004-42653
[Patent document 2] Japanese Unexamined Patent Publication No. 2007-182519
[Patent document 3] Japanese Patent Publication No. 2658200
[Patent document 4] Japanese Unexamined Patent Publication HEI No. 6-100629
[Patent document 5] Japanese Unexamined Patent Publication HEI No. 10-7866
[Patent document 6] Japanese Unexamined Patent Publication HEI No. 7-207029
[Patent document 7] Japanese Unexamined Patent Publication HEI No. 7-225490

### SUMMARY OF THE INVENTION

### Problems to be Solved by the Invention

It is an object of the present invention to provide a curable resin composition for a hard coat layer that is capable of forming a hard coat layer with a desired irregular shape on the surface without impairing transparency or mar-proofness, as well as a hard coat film employing the curable resin composition for a hard coat layer.

### Means for Solving the Problems

As a result of much diligent research, the present inventors have discovered that by including reactive inorganic fine particles A with a specific mean primary particle size and hydrophilic fine particles B with a specific mean primary particle size in a curable resin composition for a hard coat layer, it is possible to obtain a hard coat film provided with a desired irregular shape on the hard coat layer surface while maintaining transparency and mar-proofness, and the invention has been completed upon this discovery.

Specifically, the invention provides a curable resin composition for a hard coat layer comprising at least:

(1) reactive inorganic fine particles A having a mean primary particle size of from 5 nm to 80 nm, having at least a portion of the surfaces covered with an organic component so that the reactive functional group a introduced by the organic component is present on the surfaces;

(2) hydrophilic fine particles B having a mean primary particle size of from 100 nm to 300 nm; and

(3) a curable reactive matrix containing a binder component C that has a reactive functional group c with crosslinking reactivity for the reactive functional group a of the reactive inorganic fine particles A,

wherein the content of the hydrophilic fine particles B is 0.1-5.0 wt % with respect to the total solid content.

In an optical laminate having at least one laminated layer of the cured product from a curable resin composition for a hard coat layer, the hardness of the total laminated resin layer on the base, whether a monolayer or multilayer, is represented by an indentation depth of no greater than 1.3 μm, as measured with an indentation load of 10 mN. An optical laminate having such hardness can effectively prevent sticking between mirror surfaces if the aforementioned irregular shape is present.

By including reactive inorganic fine particles A with a mean primary particle size in the aforementioned range in the curable resin composition for a hard coat layer according to the invention, it is possible to obtain a hard coat film provided with a desired irregular shape on the hard coat layer surface, while maintaining a sufficiently small content of the hydrophilic fine particles B with a mean primary particle size in the aforementioned range, so as not to impair the transparency. Since the reactive functional group a of the reactive inorganic fine particles A and the reactive functional group c of the curable binder component C in the curable reactive matrix form crosslinked bonds, the resulting hard coat film exhibits high hard coat properties.

The reactive inorganic fine particles A in the curable resin composition for a hard coat layer of the invention are preferably reactive silica fine particles.

The surfaces of the reactive inorganic fine particles A are hydrophobic, that is, they are wettable with hydrophobic solvents, and they, therefore, have improved affinity with the binder component C described hereunder and can be uniformly dispersed in the binder.

The hydrophilic fine particles B of the invention, on the other hand, have hydrophilic surfaces and are desirable since, although they mix with the hydrophobic binder during the coated film-forming process, they tend to separate from the hydrophobic environment and bleed out near the film surface, forming irregularities on the surface. According to the invention, the “hydrophilic” property is judged based on wettability with alcohols. This therefore means a degree of hydrophilicity that is not so much wettability with water and that allows coexistence in hydrophobic environments as well.

The reactive functional group a of the reactive inorganic fine particles A and the reactive functional group c of the binder component C in the curable resin composition for a hard coat layer of the invention are preferably polymerizable unsaturated groups.

The binder component C in the curable resin composition for a hard coat layer of the invention is preferably a compound with three or more reactive functional groups c.

The binder C is preferably also hydrophobic, that is, soluble in hydrophobic solvents.

The hard coat film of the invention is also provided with a hard coat layer comprising the cured product of a curable resin composition for a hard coat layer according to the invention on a transparent base film, whereby it is possible to provide a hard coat film having the desired irregular shape on the hard coat layer surface, without impairing the transparency and mar-proofness of the hard coat layer.

The hydrophilic fine particles B in the hard coat layer of the hard coat film of the invention form irregularities on the hard coat layer surface, of which the raised sections have heights from 3 nm to 50 nm, and the spacings between the raised sections are 50 nm-5 μm.

According to the invention, since the desired irregular shape is formed on the surface of the hard coat layer, it is possible to prevent sticking between the surface of the hard coat layer side of the hard coat film and the surface of the base film side of the hard coat film when the hard coat film is a long roll that has been continuously taken up into the form of a continuous tape.

The film thickness of the hard coat layer in the hard coat film of the invention is preferably from 1 μm to 50 μm.

The hard coat film of the invention is suitable for use as a long film roll that has been continuously taken up in the form of a continuous tape.

### Effect of the Invention

By including reactive inorganic fine particles A with a mean primary particle size in the aforementioned range in the curable resin composition for a hard coat layer according to the invention, it is possible to obtain a hard coat film displaying a desired irregular shape on the hard coat layer surface, while maintaining a sufficiently small content of the hydrophilic fine particles B with a mean primary particle size in the aforementioned range, so as not to impair the transparency. Since the reactive functional group a of the reactive inorganic fine particles A and the reactive functional group c of the curable binder component C in the curable reactive matrix form a crosslinked bond, the resulting hard coat film exhibits high hard coat properties.

Moreover, the hard coat film of the invention can prevent sticking between the surface of the hard coat layer side of the hard coat film and the surface of the base film side of the hard coat film when the hard coat film is a long roll that has been continuously taken up into the form of a continuous tape.

### DESCRIPTION OF THE PREFERRED EMBODIMENTS

The present invention relates to a curable resin composition for a hard coat layer, and to a hard coat film employing the curable resin composition. The curable resin composition for a hard coat layer and the hard coat film will now be described in order.

### I. Curable Resin Composition for Hard Coat Layer

A curable resin composition for a hard coat layer according to the invention will now be described.

The curable resin composition for a hard coat layer according to the invention is characterized by comprising at least:

(1) reactive inorganic fine particles A having a mean primary particle size of from 5 nm to 80 nm, having at least a portion of the surfaces covered with an organic component so that the reactive functional group a introduced by the organic component is present on the surfaces;

(2) hydrophilic fine particles B having a mean primary particle size of from 100 nm to 300 nm; and

(3) a curable reactive matrix containing a binder component C that has a reactive functional group c with crosslinking reactivity for the reactive functional group a of the reactive inorganic fine particles A,

wherein the content of the hydrophilic fine particles B is 0.1-5.0 wt % with respect to the total solid content.

By including reactive inorganic fine particles A with a mean primary particle size in the aforementioned range in the curable resin composition for a hard coat layer according to the invention, it is possible to obtain a hard coat film displaying a desired irregular shape on the hard coat layer surface, while maintaining a sufficiently small content of the hydrophilic fine particles B with a mean primary particle size in the aforementioned range, so as not to impair the transparency. Since the reactive functional group a of the reactive inorganic fine particles A and the reactive functional group c of the curable binder component C in the curable reactive matrix form a crosslinked bond, the resulting hard coat film exhibits high hard coat properties.

The invention will now be explained in greater detail.

The hydrophobic group of the reactive inorganic fine particles A and the hydrophilic group of the hydrophilic fine particles B tends to promote separation between the reactive inorganic fine particles A and hydrophilic fine particles B. Without being bound to any particular theory, it can be interpreted that the function and effect of the invention are exhibited as follows, based on the mean primary particle size of the reactive inorganic fine particles A which has been limited to the range specified above.

(i) Even in the presence of the hydrophilic fine particles B, the reactive inorganic fine particles A can disperse uniformly in the hard coat layer, thus allowing the hard coat performance to be exhibited across the entire layer while maintaining smoothness and high transparency.

(ii) Since the reactive inorganic fine particles A are dispersed throughout the entire hard coat layer, it is conjectured that the hydrophilic fine particles B migrate within the hard coat layer into the optimal form for coexistence with the fine particles A. Because the hydrophilic fine particles B repel the fine particles A, they are present either as single fine particles (discrete particles) or as aggregates of about 2 particles, being in approximate balance. For example, the SEM photograph shown in FIG. 1 shows them in the latter aggregated state. When discrete hydrophilic fine particles B or double aggregates thereof are present near the interface on the side of the hard coat layer opposite the transparent base film side, repulsion with the reactive inorganic fine particles A acts significantly and the hydrophilic fine particles B are forced out strongly toward the interface section (within 300 nm of the interface with air). However, although they are pushed out toward the interface section, the hydrophilic fine particles B themselves do not protrude from the hard coat layer into contact with air, and hence are covered with a film of the resin component that forms the hard coat layer, or of the resin component in combination with the reactive inorganic fine particles A. This allows the hard coat layer to satisfactorily maintain its mar-proofness.

(iii) Saponification treatment causes the hydrophilic fine particles B to become eroded by alkali and lost when they are not covered with a resin film, so that mirror surface contact bonding can no longer be prevented, but this defect does not occur when they are covered in the manner of the invention.

Since the mechanism described above results in the discrete hydrophilic fine particles B or their double aggregates being present at a suitable density at the interface, limiting the mean primary particle size of the reactive inorganic fine particles A to within the range specified above allows the content of hydrophilic fine particles B to be limited to a small amount of 0.1-5.0 w with respect to the total solid content, which permits formation of a desired irregular shape on the hard coat layer surface. On the other hand, when a large amount of the hydrophilic fine particles B is included in the curable resin composition for a hard coat layer, the hard coat layer comprising the resin composition has reduced transparency due to increased scattering within the layer.

According to the invention, the mean primary particle size of the hydrophilic fine particles B is restricted to the aforementioned range to permit formation of a desired irregular shape on the hard coat layer surface. If the mean primary particle size of the hydrophilic fine particles B exceeds the aforementioned range, the surface shape of the hard coat layer becomes roughened and the transparency of the hard coat layer is impaired due to increased surface haze, while the irregular shape on the hard coat layer surface is enlarged enough to compromise the smoothness of the hard coat layer surface and render it more susceptible to external forces.

A curable resin composition for a hard coat layer according to the invention, which contains reactive inorganic fine particles A with a specific mean primary particle size and hydrophilic fine particles B with a specific mean primary particle size in the resin composition, allows a satisfactory balance of both fine particles to be achieved in the obtained hard coat layer, so that a hard coat film having a desired irregular shape on the hard coat layer surface can be obtained without loss of transparency or mar-proofness.

Also, according to the invention, in an optical laminate having at least one laminated layer obtained by curing a curable resin composition for a hard coat layer, the hardness of the total laminated resin layer on the transparent base, whether a monolayer or multilayer, is represented by an indentation depth of no greater than 1.3 μm, as measured with an indentation load of 10 mN. Such a hardness range can effectively prevent sticking between mirror surfaces of the optical laminate when the aforementioned irregular shape is present. If the hardness is above the hardness range specified above, the irregularities may sink into the flexible hard coat side even if the irregular shape is present, making it impossible to successfully prevent sticking with the transparent base. Since it is preferred for the hardness of the resin layer to be as high as possible, there is no particular lower limit for the indentation depth.

The constituent components of the curable resin composition for a hard coat layer according to the invention will now be described in order.

Throughout the present specification, “(meth)acryloyl” refers to acryloyl and methacryloyl, and “(meth)acrylate” refers to acrylate and methacrylate. The term “light” used throughout the present specification refers not only to visible light and electromagnetic waves with wavelengths in the non-visible light range, but also particle beams such as electron beams and radiation or ionizing radiation that include electromagnetic waves and particle beams.

The reactive functional group a and reactive functional group c referred to throughout the present specification also include photocuring functional groups and/or thermosetting functional groups. A photocuring functional group is a functional group that undergoes polymerization reaction or crosslinking reaction under light irradiation to allow formation of a cured coated film, and as examples there may be mentioned groups that undergo such reactions as polymerization reactions including photoradical polymerization, photocationic polymerization or photoanionic polymerization, or addition polymerization and condensation polymerization that proceed by photodimerization. A thermosetting functional group, throughout the present specification, refers to a functional group that undergoes polymerization reaction or crosslinking reaction with the same functional groups or other functional groups by heating, to allow formation of a cured coated film.

The reactive functional group a and reactive functional group c used for the invention are preferably polymerizable unsaturated groups, and more preferably they are photocuring unsaturated groups and even more preferably ionizing radiation-curing unsaturated groups, from the viewpoint of improving the hardness of the cured film. As specific examples, there may be mentioned ethylenic unsaturated bonds such as (meth)acryloyl, vinyl and allyl, and epoxy groups.

The mean primary particle size, throughout the present specification, refers to the 50% particle size (d₅₀: median diameter), where the particles in solution are measured by the dynamic light scattering method and the particle size distribution is expressed as cumulative distribution. The mean primary particle size can be measured using a Microtrac particle size analyzer by Nikkiso Co., Ltd.

### <Reactive Inorganic Fine Particles A>

Inorganic fine particles are commonly included in hard coat layers to maintain transparency while improving hard coat properties. The inorganic fine particles with crosslinking reactivity undergo crosslinking reaction with a curable binder to form a crosslinked structure, to further improve the hard coat properties. The reactive inorganic fine particles A are inorganic fine particles having an organic component covering at least part of the surfaces of the inorganic fine particles serving as the core, and having reactive functional groups on the surfaces introduced by the aforementioned organic component. The reactive inorganic fine particles A include those having two or more inorganic fine particles as the core per particle. The reactive inorganic fine particles A may be reduced in particle size to increase the points of crosslinking in the matrix, with respect to their content.

In order to notably improve the hardness for adequate mar-proofness according to the invention, it preferably contains reactive inorganic fine particles A having an organic component covering at least part of the surface and having reactive functional groups a introduced by the organic component. The reactive inorganic fine particles A may also impart a function to the hard coat layer, and may be appropriately selected according to the purpose.

As examples of inorganic fine particles, there may be mentioned metal oxide fine particles such as silica, aluminum oxide, zirconia, titania, zinc oxide, germanium oxide, indium oxide, tin oxide, indium tin oxide (ITO), antimony oxide or cerium oxide, and metal fluoride fine particles such as magnesium fluoride or sodium fluoride. There may also be used metal fine particles, metal sulfide fine particles or metal nitride fine particles.

Silica and aluminum oxide are preferred from the viewpoint of achieving high hardness. In order to achieve a relatively high refractive index layer, fine particles such as zirconia, titania or antimony oxide may be appropriately selected to increase the refractive index during film formation. Similarly, in order to achieve a relatively low refractive index layer, fine particles may be appropriately selected that will lower the refractive index during film formation, including fluoride fine particles such as magnesium fluoride or sodium fluoride. When it is desired to impart antistatic or conductive properties, indium tin oxide (ITO), tin oxide or the like may be appropriately selected for use. These may be used either alone or in combinations of two or more.

The surfaces of the inorganic fine particles will normally have groups that cannot exist in that form inside the inorganic fine particles. These surface groups will usually be relatively reactive functional groups. For example, in the case of a metal oxide they will be hydroxyl and oxy groups, in the case of a metal sulfide they will be thiol and thio groups, and in the case of a nitride they will be amino, amide and imide groups.

From the viewpoint of mar-proofness, the inorganic fine particles serving as the cores of the reactive inorganic fine particles A of the invention are preferably reactive silica fine particles.

Also, the reactive inorganic fine particles A according to the invention are preferably solid particles without voids or porous structures in the particle interiors, rather than particles with voids or porous structures in the particle interiors, such as hollow particles. Because hollow particles have voids or porous structures, their hardness is lower than solid particles, while hollow particles also have a lower apparent specific gravity (mass per unit volume, averaged including the hollow sections) than solid particles, such that hollow particles tend to be increased at the interface opposite from the transparent base film side of the hard coat layer (i.e., the air interface). Because of the excluded volume effect of the reactive inorganic fine particles A, it is preferred, from the standpoint of maldistribution of the hydrophilic fine particles B at the air interface side, for the reactive inorganic fine particles A to be solid particles, rather than hollow particles which tend to be maldistributed at the air interface side. Consequently, the reactive inorganic fine particles A preferably employ solid particles that have high hardness and a higher specific gravity than hollow particles.

The reactive inorganic fine particles A used for the invention have an organic component covering at least part of the surfaces, and have reactive functional groups on the surfaces introduced by the aforementioned organic component. As used herein, the organic component is a carbon-containing component. Modes wherein the organic component covers at least part of the surfaces include a mode in which a compound containing an organic component such as a silane coupling agent is reacted with the hydroxyl groups on the surfaces of metal oxide fine particles, bonding the organic component to part of the surfaces, a mode in which an organic component is attached to the hydroxyl groups on the surfaces of metal oxide fine particles by interaction such as hydrogen bonding, and a mode in which one or more inorganic fine particles are contained in the polymer particles.

The covering organic component inhibits aggregation between the inorganic fine particles and increases the number of reactive functional groups introduced onto the inorganic fine particle surfaces, thus improving the film strength, and therefore preferably it covers essentially the entirety of the particle surfaces. From this viewpoint, the organic component covering the inorganic fine particles is preferably included in the reactive inorganic fine particles at 1.00×10⁻³ g/m² or greater. For the mode where the organic component is attached or bonded to the inorganic fine particle surfaces, the organic component covering the inorganic fine particles is more preferably included in the reactive inorganic fine particles A at 2.00×10⁻³ g/m² or greater and even more preferably it is included in the reactive inorganic fine particles A at 3.50×10⁻³ g/m² or greater. For the mode where inorganic fine particles are included in the polymer particles, the organic component covering the inorganic fine particles is more preferably included in the reactive inorganic fine particles A at 3.50×10⁻³ g/m² or greater, and even more preferably, it is included in the reactive inorganic fine particles A at 5.50×10⁻³ g/m² or greater.

Normally, the proportion of the covering organic component can be determined by, for example, thermogravimetric analysis in the air from room temperature to usually 800° C., in terms of the constant mass value of weight reduction when the dry powder has undergone complete combustion in the air.

The amount of organic component per unit area is determined by the following method. First, using differential thermogravimetry (DTG), the organic component weight is measured and divided by the inorganic component weight (organic component weight/inorganic component weight). Next, the volume of the entire inorganic component is calculated from the inorganic component weight and the specific gravity of the inorganic fine particles used. Assuming that the inorganic fine'particles are spherical before covering, the volume and the surface area per inorganic fine particle before covering are calculated from the mean particle size of the inorganic fine particles before covering. The volume of the entire inorganic component is then divided by the volume per inorganic fine particle before covering, to determine the number of reactive inorganic fine particles A. Dividing the organic component weight by the number of reactive inorganic fine particles A gives the amount of organic component per reactive inorganic fine particle A. Finally, the organic component weight per reactive inorganic fine particle A is divided by the surface area per inorganic fine particle before covering, to determine the amount of organic component per unit area.

From the viewpoint of improving hardness without impairing transparency, the mean primary particle size of the reactive inorganic fine particles A is from 5 nm to 80 nm, and most preferably from 30 nm to 70 nm.

The reactive inorganic fine particles A may be aggregates, in which case not only the primary particle size but also the secondary particle size may be within the aforementioned range.

As the method for preparing the reactive inorganic fine particles A having an organic component covering at least part of their surfaces and having reactive functional groups on the surfaces introduced by the aforementioned organic component, there may be used any conventional method appropriately selected depending on the reactive functional group a that is to be introduced into the inorganic fine particles.

According to the invention, the covering organic component can be included in the reactive inorganic fine particles A in an amount of 1.00×10⁻³ g/m² or greater per unit area of the inorganic fine particles before covering, and from the viewpoint of inhibiting aggregation of the inorganic fine particles and improving the film strength, it is preferred to select one of the following types of inorganic fine particles (i) (ii) and (iii) as appropriate.

(i) Inorganic fine particles having reactive functional groups on the surface, obtained by dispersing inorganic fine particles in water and/or an organic solvent as the dispersing medium, in the presence of one or more surface-modifying compounds with a molecular weight of no greater than 500, selected from the group consisting of saturated or unsaturated carboxylic acids, acid anhydrides, acid chlorides, esters or acid amides corresponding to the carboxylic acids, amino acids, imines, nitriles, isonitriles, epoxy compounds, amines, β-dicarbonyl compounds, silanes and functional group-containing metal compounds.

(ii) Inorganic fine particles having reactive functional groups on the surface, obtained by discharging a monomer comprising inorganic fine particles with particle sizes from 5 nm to 80 nm dispersed in a hydrophobic vinyl monomer, into water through a hydrophilized porous membrane, to form an aqueous dispersion of inorganic fine particle-dispersed monomer droplets, and then polymerizing the dispersion.

(iii) Inorganic fine particles having reactive functional groups on the surface, obtained by bonding metal oxide fine particles with a compound containing the reactive functional group introduced into the inorganic fine particles before covering, a group represented by chemical formula (1) below and a silanol group or a group that produces a silanol group by hydrolysis.

Chemical formula (1)

-Q¹-C(=Q²)-NH—

[In chemical formula (1), Q¹ represents NH, O (oxygen atom) or S (sulfur atom), and Q² represents O or S].

Reactive inorganic fine particles A suitable for use according to the invention will now be described.

(i) Inorganic fine particles having reactive functional groups on the surface, obtained by dispersing inorganic fine particles in water and/or an organic solvent as the dispersing medium, in the presence of one or more surface-modifying compounds with a molecular weight of no greater than 500, selected from the group consisting of saturated or unsaturated carboxylic acids, acid anhydrides, acid chlorides, esters or acid amides corresponding to the carboxylic acids, amino acids, imines, nitriles, isonitriles, epoxy compounds, amines, β-dicarbonyl compounds, silanes and functional group-containing metal compounds.

Using reactive inorganic fine particles A of (i) above is advantageous in that the film strength can be improved without lowering the organic component content.

The surface-modifying compound used in the reactive inorganic fine particles A of (i) above has a functional group that can chemically bond with a group on the surface of the inorganic fine particles under dispersion conditions, such as carboxyl, acid anhydride, acid chloride, acid amid, ester, imino, nitrile, isonitrile, hydroxyl, thiol or epoxy groups, primary, secondary or tertiary amino groups, Si—OH group or silane hydrolyzable residue, or a C—H acid group such as a β-dicarbonyl compound. As used herein, the chemical bonding may be a covalent bonding, ionic bonding or coordination bonding, or even hydrogen bonding. Coordination bonding may occur in the formation of a complex. For example, Bronsted or Lewis acid-base reaction, complex formation or esterification occurs between the functional groups of the surface-modifying compound and the groups on the inorganic fine particle surfaces. Surface-modifying compounds for the reactive inorganic fine particles A of (i) above may be used alone or in combinations of two or more.

In addition to the one or more functional groups (hereinafter referred to as “first functional group”) that can participate in chemical bonding with groups on the surfaces of the inorganic fine particles, the surface-modifying compound will also generally have molecular residues that can impart new properties to the inorganic fine particles after bonding to the surface-modifying compound via the functional groups. The molecular residues, or a portion of them, may be hydrophobic or hydrophilic and may serve for stabilization, compatibilization or activation of the inorganic fine particles, for example.

As examples of hydrophobic molecular residues there may be mentioned alkyl, aryl, alkallyl, aralkyl and fluorine-containing alkyl groups, that can produce inactivation or repulsion. As hydrophilic groups there may be mentioned hydroxy, alkoxy and polyester groups.

The surface-introduced reactive functional group a that allows the reactive inorganic fine particles A to react with the binder component C described hereunder is appropriately selected depending on the binder component C. The reactive functional group a may be a polymerizable unsaturated group, and preferably it is a photocuring unsaturated group and more preferably an ionizing radiation-curing unsaturated group. As specific examples there may be mentioned those with ethylenic double bonds such as (meth)acryloyl, vinyl and allyl groups.

When the molecular residue of the surface-modifying compound contains the reactive functional group a that can react with the binder component C, the first functional group in the surface-modifying compound can be reacted with the inorganic fine particle surfaces to introduce the reactive functional group a that can react with the binder component C onto the surfaces of the reactive inorganic fine particles A of (i) above. For example, surface-modifying compounds with polymerizable unsaturated groups in addition to the first functional group may be mentioned as preferred ones.

Alternatively, the reactive functional group a that can react with the binder component C may be introduced onto the surfaces of the reactive inorganic fine particles A of (i) above by including a second reactive functional group in the molecular residues of the surface-modifying compound and using the second reactive functional group as a scaffold. For example, preferably a group that can undergo hydrogen bonding (hydrogen bond-forming group) such as a hydroxyl or oxy group is introduced as the second reactive functional group and the hydrogen bond-forming group of another surface-modifying compound reacted with the hydrogen bond-forming group introduced onto the fine particle surfaces, to introduce the reactive functional group a that can react with the binder component C. That is, a preferred example of the surface-modifying compound is a compound with a hydrogen bond-forming group used in combination with a compound with a hydrogen bond-forming group and a reactive functional group a that can react with the binder component C, such as a polymerizable unsaturated group. As specific examples of hydrogen bond-forming groups, there may be mentioned functional groups such as hydroxyl, carboxyl, epoxy, glycidyl and amide groups, or amide bonds. As used herein, the amide bond is one containing —NHC(O)— or >NC(O)— as the bonding unit. Preferred among these for the hydrogen bond-forming group used in the surface-modifying compound of the invention are carboxyl, hydroxyl and amide groups.

The surface-modifying compound used in the reactive inorganic fine particles A of (i) above has a molecular weight of no greater than 500, more preferably no greater than 400 and especially not exceeding 200. It is conjectured that it is this low molecular weight that allows it to rapidly occupy the fine particle surfaces and while preventing aggregation between the inorganic fine particles.

The surface-modifying compound used in the reactive inorganic fine particles A of (i) above is preferably a liquid under the reaction conditions used to modify the surfaces, and is preferably soluble or at least emulsifiable in the dispersing medium. More preferably, it is soluble in the dispersing medium and uniformly disperses as dissociated molecules or molecular ions in the dispersing medium.

As saturated or unsaturated carboxylic acids, there may be mentioned those with 1-24 carbon atoms, such as formic acid, acetic acid, propionic acid, butyric acid, valeric acid, caproic acid, acrylic acid, methacrylic acid, crotonic acid, citric acid, adipic acid, succinic acid, glutaric acid, oxalic acid, maleic acid, fumaric acid, itaconic acid and stearic acid, as well as their corresponding acid anhydrides, chlorides, esters and amides, and caprolactam may be mentioned as an example. Using an unsaturated carboxylic acid allows introduction of a polymerizable unsaturated group.

Examples of preferred amines are those having the chemical formula Q₃₋ₙNHₙ (n=0, 1 or 2), where each residue Q independently represents alkyl with 1-12, especially 1-6 and preferably 1-4 carbon atoms (for example, methyl, ethyl, n-propyl, i-propyl or butyl) or aryl, alkallyl or aralkyl with 6-24 carbon atoms (for example, phenyl, naphthyl, tolyl or benzyl). Polyalkyleneamines may be mentioned as examples of preferred amines, and specifically methylamine, dimethylamine, trimethylamine, ethylamine, aniline, N-methylaniline, diphenylamine, triphenylamine, toluidine, ethylenediamine and diethylenetriamine.

Preferred β-dicarbonyl compounds have 4-12 and especially 5-8 carbon atoms, and as examples there may be mentioned diketones (acetylacetone and the like), 2,3-hexanedione, 3,5-heptanedione, acetoacetic acid, acetoacetic acid C₁-C₄-alkyl esters (ethyl acetoacetate and the like), diacetyl and acetonylacetone.

As examples of amino acids there may be mentioned β-alanine, glycine, valine, aminocaproic acid, leucine and isoleucine.

Preferred silanes are hydrolyzable organosilanes with at least one hydrolyzable group or hydroxy group and at least one non-hydrolyzable residue. As examples of hydrolyzable groups herein, there may be mentioned halogen, alkoxy and acyloxy groups. As non-hydrolyzable residues, there may be used non-hydrolyzable residues with a reactive functional group a and/or without a reactive functional group a. A silane partially containing at least a fluorine-substituted organic residue may also be used.

There are no particular restrictions on the silane used, and as examples there may be mentioned CH₂═CHSi(OOCCH₃)₃, CH₂═CHSiCl₃, CH₂═CHSi(OC₂H₅)₃, CH₂═CH—Si(OC₂H₄OCH₃)₃, CH₂═CH—CH₂—Si(OC₂H₅)₃, CH₂═CH—CH₂—Si(OOCCH₃)₃, γ-glycidyloxypropyltrimethoxysilane (GPTS), γ-glycidyloxypropyldimethylchlorosilane, 3-aminopropyltrimethoxysilane (APTS), 3-aminopropyltriethoxysilane (APTES), N-(2-aminoethyl)-3-aminopropyltrimethoxysilane, N—[N′-(2′-aminoethyl)-2-aminoethyl]-3-aminopropyltrimethoxysilane, hydroxymethyltrimethoxysilane, 2-[methoxy(polyethyleneoxy)propyl]trimethoxysilane, bis-(hydroxyethyl)-3-aminopropyltriethoxysilane, N-hydroxyethyl-N-methylaminopropyltriethoxysilane, 3-(meth)acryloxypropyltriethoxysilane and 3-(meth)acryloxypropyltrimethoxysilane.

As metal compounds with functional groups there may be mentioned metal compounds with a metal M from Groups IIIA-VA and/or Groups IIB-IVB of the Periodic Table. Alkoxides of zirconium and titanium: M(OR)₄ (M=Ti, Zr) (wherein a portion of the OR groups are substituted with a complexing agent such as a β-dicarbonyl compound or monocarboxylic acid) may also be mentioned. Using a compound with a polymerizable unsaturated group (such as methacrylic acid) as a complexing agent allows introduction of a polymerizable unsaturated group.

The dispersing medium used is preferably water and/or an organic solvent. Distilled water (pure) is particularly preferred as the dispersing medium. Polar and non-polar aprotic solvents are preferred as organic solvents. As examples there may be mentioned alcohols including C₁₋₆ aliphatic alcohols (especially methanol, ethanol, n- and i-propanol and butanol); ketones such as acetone and butanone; esters such as ethyl acetate; ethers such as diethyl ether, tetrahydrofuran and tetrahydropyran; amides such as dimethylacetamide and dimethylformamide; sulfoxides and sulfones such as sulfolane and dimethyl sulfoxide; and aliphatic (optionally halogenated) hydrocarbons such as pentane, hexane and cyclohexane. These dispersing mediums may also be used as mixtures.

The dispersing medium preferably has a boiling point allowing it to be easily removed by distillation (optionally under reduced pressure), and it is preferably a solvent with a boiling point of no higher than 200° C. and especially no higher than 150° C.

For preparation of the reactive inorganic fine particles A of (i), the concentration of the dispersing medium will normally be 40-90 wt %, preferably 50-80 wt % and especially 55-75 wt %. The remaining dispersion will be composed of untreated inorganic fine particles and the aforementioned surface-modifying compound. As used herein, the weight ratio of the inorganic fine particles/surface-modifying compound is preferably 100:1-4:1, more preferably 50:1-8:1 and even more preferably 25:1-10:1.

Preparation of the reactive inorganic fine particles A of (i) is preferably carried out at between room temperature (about 20° C.) and the boiling point of the dispersing medium. Most preferably, the dispersion temperature is 50-100° C. The dispersion time will depend on the type of material used, but for most purposes it is from several minutes to several hours, and for example, 1-24 hours.

(ii) Inorganic fine particles having reactive functional groups on the surface, obtained by discharging a monomer comprising inorganic fine particles with particle sizes from 5 nm to 80 nm dispersed in a hydrophobic vinyl monomer, into water through a hydrophilized porous membrane, to form an aqueous dispersion of inorganic fine particle-dispersed monomer droplets, and then polymerizing the dispersion.

Using reactive inorganic fine particles A according to (ii) above is advantageous from the viewpoint of the particle size distribution, in that the monodisperse property is increased and irregular performance when coarse particles are present can be minimized.

Since the reactive inorganic fine particles A used for the invention are inorganic fine particles with an organic component covering at least part of the surfaces and thus having reactive functional groups on their surfaces which are introduced by the organic component, either the reactive functional group a or a different reactive functional group that allows subsequent introduction of the desired reactive functional group a is included in the hydrophobic vinyl monomer used for polymerization during production of the reactive inorganic fine particles A of type (ii). For example, a hydrophobic vinyl monomer already containing a carboxyl group may be polymerized, and then glycidyl methacrylate reacted with the carboxyl group to introduce a polymerizable unsaturated group.

As specific examples of hydrophobic vinyl monomers there may be mentioned aromatic vinyl compounds such as styrene, vinyltoluene, α-methylstyrene and divinylbenzene; unsaturated carboxylic acid esters such as methyl (meth)acrylate, 2-hydroxyethyl (meth)acrylate, t-butyl (meth)acrylate, n-hexyl (meth)acrylate, isobutyl (meth)acrylate, cyclohexyl (meth)acrylate, 2-ethylhexyl (meth)acrylate, lauryl (meth)acrylate, stearyl (meth)acrylate, benzyl (meth)acrylate, (poly)ethylene glycol mono- or di(meth)acrylate, (poly)propylene glycol mono- or di(meth)acrylate, 1,4-butanediol mono- or di-(meth)acrylate, trimethylolpropane mono-, di- or tri-(meth)acrylate and the like; allyl compounds such as diallyl phthalate, diallylacrylamide, triallyl (iso)cyanurate, triallyltrimellitate, and (poly)oxyalkyleneglycol di(meth)acrylates such as (poly)ethyleneglycol di(meth)acrylate and (poly)propyleneglycol di(meth)acrylate. There may also be mentioned conjugated diene compounds such as butadiene, isoprene and chloroprene. There may further be mentioned reactive functional group-containing monomers such as acrylic acid, methacrylic acid, itaconic acid, fumaric acid, glycidyl methacrylate, vinylpyridine, diethylaminoethyl acrylate, N-methylmethacrylamide and acrylonitrile. Among these, monomers with high water-solubility such as acrylic acid, methacrylic acid and itaconic acid have high water solubility overall as monomers, and may be used in ranges that do not produce oil-droplet monomer emulsions in water.

The inorganic fine particles used for (ii) must have small particle sizes and must disperse satisfactorily in hydrophobic vinyl monomers. The particle sizes of the inorganic fine particles used are no greater than 80 nm, preferably no greater than 80 nm and even more preferably no greater than 70 nm. If the inorganic fine particles are poorly compatible with the hydrophobic vinyl monomer, it is preferred for the fine particle surfaces to be subjected to prior surface treatment. Surface treatment may employ a known method such as dispersing agent treatment whereby a pigment dispersant is adsorbed onto the fine particle surfaces, coupling agent treatment with a silane coupling agent or titanate coupling agent, or polymer coating treatment by capsule polymerization or the like.

In order to emulsify the inorganic fine particle-dispersed hydrophobic vinyl monomer in water for (ii), it is discharged into water through a hydrophilized porous membrane. The pores must have a mean pore size of 0.01-5 μm and must have uniform pore sizes, and must penetrate from the front to the back of the membrane. Glass is preferred as the material for the membrane, and specific examples include Shirasu Porous Glass (SPG) obtained by microphase separation (by heat treatment) of SiO₂—Al₂O₃—B₂O₃—CaO glass prepared by firing Shirasu volcanic ash as the main starting material, and dissolving/removing the boric acid-rich phase with an acid.

For (ii) above, a surfactant or water-soluble polymer must be present as a stabilizer for the monomer droplets in the aqueous phase into which the inorganic fine particle-containing hydrophobic vinyl monomer is extruded through the porous membrane. If no stabilizer is used, the monomer droplets discharged through the membrane will fuse together, resulting in a wide particle size distribution. Preferred stabilizers include water-soluble polymer-based stabilizers such as polyvinyl alcohol, hydroxypropylcellulose and polyvinylpyrrolidone, for monomer droplets of about 1 μm and larger, and preferably an anionic surfactant or nonionic emulsifier is also added. For example, a combination of sodium lauryl sulfate as an emulsifier and 1-hexadecanol as a co-emulsifier firmly adsorbs onto the droplet surfaces to provide a significant stabilizing effect, and is particularly preferred as the stabilizer for (ii).

In most cases, an oil-soluble radical initiator will be used for polymerization of the aqueous dispersion of emulsified inorganic fine particle-containing monomer droplets, for (ii) above. As examples of initiators to be used as oil-soluble radical initiators, there may be mentioned azo-based initiators such as azobisisobutyronitrile, aromatic peroxides such as benzoyl peroxide and 2,4-dichlorbenzoyl peroxide, and aliphatic peroxides such as isobutyl peroxide, diisopropylperoxy dicarbonate and di(2-ethylhexylperoxy)dicarbonate. These may be used by dissolution in the monomer phase before emulsification. A water-soluble radical polymerization inhibitor such as hydroquinone or iron chloride may also be added.

(iii) Inorganic fine particles having reactive functional groups on the surface, obtained by bonding metal oxide fine particles, as inorganic fine particles to serve as the core, with a compound containing the reactive functional group introduced into the inorganic fine particles before covering, a group represented by chemical formula (1) below and a silanol group or a group that produces a silanol group by hydrolysis.

-Q¹-C(=Q²)-NH— Chemical formula (1)

(In Chemical formula (1), Q¹ represents NH, O (oxygen atom) or S (sulfur atom), and Q² represents O or S).

Using the reactive inorganic fine particles A of (iii) above is advantageous in that the organic component is increased and the dispersibility and film strength are further increased.

First, compounds containing a group represented by chemical formula (1) above and a silanol group or a group that produces a silanol group by hydrolysis (hereinafter also referred to as “reactive functional group-modified hydrolyzable silane”) will be explained for the reactive functional group to be introduced into the inorganic fine particles before covering.

The reactive functional group a to be introduced into the inorganic fine particles, in the reactive functional group-modified hydrolyzable silane, is not particularly restricted so long as it is appropriately selected to be reactive with the binder component C. It is one that is appropriate for introduction of the polymerizable unsaturated group.

In the reactive functional group-modified hydrolyzable silane, the group [-Q¹-C(=Q²)-NH—] represented by chemical formula (1) above includes, specifically, the six groups [—O—C(═O)—NH—], [—O—C(═S)—NH—], [—S—C(═O)—NH—], [—NH—C(═O)—NH—], [—NH—C(═S)—NH—] and [—S—C(═S)—NH—].

These groups may be used either alone or in combinations of two or more. From the viewpoint of thermostability, it is preferred to use at least one from among the groups [—O—C(═O)—NH—], [—O—C(═S)—NH—] and [—S—C(═O)—NH—]. A group [-Q¹-C(=Q²)-NH—] represented by chemical formula (1) generates suitable cohesion by hydrogen bonding between molecules to achieve curing, and thereby imparts properties such as excellent mechanical strength, adhesiveness with base materials and heat resistance.

As groups that produce silanol groups by hydrolysis there may be mentioned groups having alkoxy, aryloxy, acetoxy and amino groups or halogen atoms on silicon atoms, and preferably alkoxysilyl or aryloxysilyl groups. The silanol group or the group that produces a silanol group by hydrolysis can bond with the metal oxide fine particles either by condensation reaction or by condensation reaction following hydrolysis.

As specific preferred examples of reactive functional group-modified hydrolyzable silanes there may be mentioned compounds represented by chemical formula (2) below.

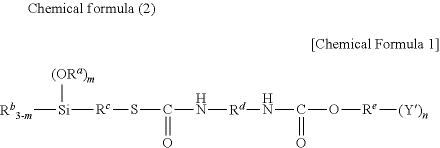

In chemical formula (2), R^{a} and R^{b} may be the same or different and represent hydrogen atoms or C₁-C₈ alkyl or aryl groups, and as examples there may be mentioned methyl, ethyl, propyl, butyl, octyl, phenyl and xylyl. The letter m represents 1, 2 or 3.

As examples of groups represented by [(R^{a}O)ₘR^{b}₃₋ₘSi—], there may be mentioned trimethoxysilyl, triethoxysilyl, triphenoxysilyl, methyldimethoxysilyl and dimethylmethoxysilyl groups. Trimethoxysilyl and triethoxysilyl are preferred among such groups.

R^{c} is a divalent organic group with a C₁-C₁₂ aliphatic or aromatic structure, and it may also include a straight-chain, branched or cyclic structure. As examples of such organic groups, there may be mentioned methylene, ethylene, propylene, butylene, hexamethylene, cyclohexylene, phenylene, xylylene and dodecamethylene. Preferred among these are methylene, propylene, cyclohexylene and phenylene.

R^{d} is a divalent organic group, and it will generally be selected from among divalent organic groups with molecular weights of 14-10,000 and preferably molecular weights of 76-500. As examples there may be mentioned straight-chain polyalkylene groups such as hexamethylene, octamethylene and dodecamethylene; alicyclic or polycyclic divalent organic groups such as cyclohexylene and norbornylene; divalent aromatic groups such as phenylene, naphthylene, biphenylene and polyphenylene; and alkyl group-substituted or aryl group-substituted forms of the foregoing. These divalent organic groups may include atomic groups containing elements other than carbon and hydrogen, and may also include polyether bonds, polyester bonds, polyamide bonds and polycarbonate bonds, as well as groups represented by chemical formula (1) above.

R^{e} is an (n+1)-valent organic group, and is preferably selected from among straight-chain, branched or cyclic saturated hydrocarbon and unsaturated hydrocarbon groups.

Y′ represents a monovalent organic group with a reactive functional group. It may also be the aforementioned reactive functional group itself. For example, when the reactive functional group a is selected from among polymerizable unsaturated groups, there may be mentioned (meth)acryloyl(oxy), vinyl(oxy), propenyl(oxy), butadienyl(oxy), styryl(oxy), ethynyl(oxy), cinnamoyl(oxy), maleate and (meth)acrylamide groups. The letter n is a positive integer of preferably 1-20, even more preferably 1-10 and most preferably 1-5.

Synthesis of the reactive functional group-modified hydrolyzable silane used for the invention may be accomplished by the method described in Japanese Unexamined Patent Publication HEI No. 9-100111, for example. Specifically, a polymerizable unsaturated group, for example, may be introduced by (I) addition reaction between a mercaptoalkoxysilane, a polyisocyanate compound and an active hydrogen group-containing polymerizable unsaturated compound that can react with isocyanate groups. It may also be accomplished by (II) direct reaction between a compound with alkoxysilyl and isocyanate groups in the molecule, and the active hydrogen group-containing polymerizable unsaturated compound. It can also be accomplished by (III) direct synthesis by addition reaction between a compound with polymerizable unsaturated and isocyanate groups in the molecule, and a mercaptoalkoxysilane or aminosilane.

For preparation of the reactive inorganic fine particles A of (iii) above, there may be selected a method in which the reactive functional group-modified hydrolyzable silane is subjected to a separate hydrolysis procedure, and then mixed with inorganic fine particles, heated and stirred, a method in which hydrolysis of the reactive functional group-modified hydrolyzable silane is carried out in the presence of the inorganic fine particles, or a method in which the surface treatment of the inorganic fine particles is carried out in the presence of another component such as a polyvalent unsaturated organic compound, monovalent unsaturated organic compound, radiation polymerization initiator or the like, but hydrolysis of the reactive functional group-modified hydrolyzable silane in the presence of the inorganic fine particles is the preferred method.

The temperature for preparation of the reactive inorganic fine particles A of (iii) will normally be from 20° C. to 150° C., and the treatment time is in the range of 5 minutes-24 hours.

In order to accelerate the hydrolysis, an acid, salt or base may be added as a catalyst. As suitable acids there may be mentioned organic acids and unsaturated organic acids; and as suitable bases there may be mentioned tertiary amines and quaternary ammonium hydroxide. These acid or base catalysts may be added at 0.001-1.0 wt % and preferably 0.01-0.1 wt % with respect to the reactive functional group-modified hydrolyzable silane.

The reactive inorganic fine particles A may be powdered fine particles containing no dispersing medium, but from the viewpoint of omitting the dispersion step and increasing productivity, the fine particles are preferably in the form of a solvent-dispersed sol.

The content of the reactive inorganic fine particles A is preferably 5-70 wt % and more preferably 10-50 wt % based on the total solid content. At less than 5 wt % the hardness of the hard coat layer surface may not be sufficient, and at greater than 70 wt % the adhesiveness at the interface between the hard coat layer and transparent base film may be insufficient.

### <Hydrophilic Fine Particles B>

The hydrophilic fine particles B referred to throughout the present specification may be either organic or inorganic. As specific examples of hydrophilic fine particles B to be used for the invention, there may be mentioned inorganic fine particles of silica or alumina, and organic fine particles having hydrophilic functional groups such as hydroxyl introduced on the surfaces. In the case of organic particles, they are composed of a high molecular compound having a siloxane bond as the skeleton and containing an organic group (polymer fine particles). Examples of organic groups include hydrocarbon groups either with or without heteroatoms, polyether groups, or polyester, acrylic, urethane or epoxy groups.

The hydrophilic fine particles B are fine particles that form a desired irregular shape on the hard coat layer surface, and are included in the hard coat layer to prevent sticking of the hard coat layer surface. The shape of the hydrophilic fine particles B may be roughly spherical, such as true spherical or spheroid, but they are preferably true spherical.

The reason for restricting the fine particles to the aforementioned hydrophilic fine particles B, as the particles for forming the desired irregular shape on the hard coat layer surface according to the invention, is as follows.

The hydrophilic fine particles B are fine particles with hydrophilic surfaces, and when added in a small amount they can coexist with the reactive inorganic fine particles A in the hard coat layer without affecting the film strength or transparency, and yet, since they tend to separate from hydrophobic environments, the particles are pushed out toward the surface when present near the surface, thus forming a fine irregular shape on the surface. However, the particles themselves are present on the surface still covered by a binder resin or the like.

The mean primary particle size of the hydrophilic fine particles B used for the invention is from 100 nm to 300 nm and most preferably from 100 nm to 200 nm, from the viewpoint of maintaining transparency. If it is less than 100 nm it may not be possible to form irregularities sufficient to prevent sticking, while if it exceeds 300 nm the transparency may be impaired.

The hydrophilic fine particles B may be aggregate particles, in which case not only the primary particle size but also the secondary particle size may be within the aforementioned range.

Since the hydrophilic fine particles B tend to have low affinity for ionizing radiation-curable resins while the diffusion rate of the hydrophilic fine particles B tends to be high, it is possible to form a desired irregular shape in the hard coat layer surface for the reason explained in paragraph [0021] above, and particularly point (ii).

The content of the hydrophilic fine particles B is 0.1-5.0 wt % and most preferably 0.3-3.0 wt % with respect to the total solid content. An amount of less than 0.1 wt % may be too small to exhibit an effect, while an amount of greater than 5.0 wt % will lower the transparency of the hard coat layer.

### <Curable Reactive Matrix>

As used herein, the constituent components of the curable reactive matrix, mentioned throughout the present specification, are the binder component C, as well as curable binder components other than binder component C, polymer components, polymerization initiators and the like, as necessary, that constitute matrix components of the cured hard coat layer.

### [Binder Component C]

The binder component C in the curable resin composition for a hard coat layer of the invention has a reactive functional group c with crosslinking reactivity for the reactive functional group a of the reactive inorganic fine particles A, and a network structure is formed by crosslinked bonding between the reactive functional group a and the reactive functional group c. The binder component C preferably has three or more the reactive functional groups c in order to obtain sufficient crosslinkability. The reactive functional group c may be a polymerizable unsaturated group, and preferably it is a photocuring unsaturated group and more preferably an ionizing radiation-curing unsaturated group. As specific examples there may be mentioned those with ethylenic double bonds such as (meth)acryloyl, vinyl and allyl groups.

The binder component C is preferably translucent to allow permeation of light when the film has been coated, and as specific examples, there may be mentioned ionizing radiation-curable resins that harden with ionizing radiation such as ultraviolet rays or an electron beam, and mixtures of ionizing radiation-curable resins with solvent-drying resins (resins such as thermoplastic resins that serve as coatings simply by drying the solvent added to adjust the solid content during coating), or thermosetting resins, with ionizing radiation-curable resins being preferred.

As specific examples of ionizing radiation-curable resins, there may be mentioned compounds with radical-polymerizing functional groups such as (meth)acrylates, examples of which include (meth)acrylate-based oligomers, prepolymers and monomers. More specifically, as (meth)acrylate-based oligomers or prepolymers, there may be mentioned oligomers or prepolymers composed of (meth)acrylic acid esters of polyfunctional compounds, such as relatively low-molecular-weight polyester resins, polyether resins, acrylic resins, epoxy resins, urethane resins, alkyd resins, spiroacetal resins, polybutadiene resins, polythiolpolyene resins, polyhydric alcohols and the like. As (meth)acrylate-based monomers, there may be mentioned ethyl (meth)acrylate, ethylhexyl (meth)acrylate, hexanediol (meth)acrylate, hexanediol (meth)acrylate, tripropyleneglycol di(meth)acrylate, diethyleneglycol di(meth)acrylate, 1,6-hexanediol di(meth)acrylate, neopentyl glycol di(meth)acrylate, trimethylolpropane tri(meth)acrylate, pentaerythritol tri(meth)acrylate, dipentaerythritol hexa(meth)acrylate and the like.

As examples other than (meth)acrylate-based compounds, there may be mentioned monofunctional or polyfunctional monomers such as styrene, methylstyrene and N-vinylpyrrolidone, or compounds with cationic polymerizable functional groups such as oligomers or prepolymers of bisphenol-type epoxy compounds, novolac-type epoxy compounds, aromatic vinyl ethers, aliphatic vinyl ethers and the like.

When an ionizing radiation-curable resin is used as the ultraviolet curing resin, a sensitizing agent may be added as a photopolymerization initiator or photopolymerization accelerator.

As specific examples of photopolymerization initiators, in cases of resin systems with radical-polymerizing functional groups, there may be mentioned acetophenones, benzophenones, Michler benzoylbenzoate, α-amyloxime esters, tetramethylthiuram monosulfide, benzoins, benzoinmethyl ether, thioxanthones, propiophenones, benzyls, acylphosphine oxides, 1-hydroxy-cyclohexyl-phenyl-ketone and the like, any of which may be used alone or in mixtures. For example, 1-hydroxy-cyclohexyl-phenyl-ketone is available as IRGACURE 184, trade name of Ciba Specialty Chemicals Co., Ltd. Examples of α-aminoalkylphenones include the trade names IRGACURE 907 and 369.

When a resin with a cationic polymerizable functional group is used, the photopolymerization initiator may be an aromatic diazonium salt, aromatic sulfonium salt, aromatic iodonium salt, metallocene compound, benzoinsulfonic acid ester or the like, either alone or in combinations.

A photosensitizer is also preferably used therewith in combination, specific examples of which include n-butylamine, triethylamine and poly-n-butylphosphine.

The amount of photopolymerization initiator added is preferably 0.1-10 parts by weight with respect to 100 parts by weight of the ionizing radiation-curable composition.

Thermoplastic resins may be mentioned as solvent-drying resins to be used in combination with the ionizing radiation-curable resin. Any ordinary thermoplastic resins may be used. Addition of a solvent-drying resin can effectively prevent coating defects on the coated surface. Specific examples of preferred thermoplastic resins include styrene-based resins, (meth)acrylic-based resins, organic acid vinyl ester-based resins, vinyl ether-based resins, halogen-containing resins, olefin-based resins (including alicyclic olefin-based resins), polycarbonate-based resins, polyester-based resins, polyamide-based resins, thermoplastic polyurethane resins, polysulfone-based resins (for example, polyethersulfone and polysulfone), polyphenylene ether-based resins (for example, 2,6-xylenol polymers), cellulose derivatives (for example, cellulose esters, cellulose carbamates and cellulose ethers), hydrophilic resins, (for example, polydimethylsiloxane and polymethylphenylsiloxane), and rubbers or elastomers (for example, diene-based rubbers such as polybutadiene and polyisoprene, styrene-butadiene copolymer, acrylonitrile-butadiene copolymer, acrylic rubber, urethane rubber, silicone rubber and the like).

As specific examples of thermosetting resins, there may be mentioned phenol resins, urea resins, diallyl phthalate resins, melamine resins, guanamine resins, unsaturated polyester resins, polyurethane resins, epoxy resins, aminoalkyd resins, melamine-urea co-condensation resins, silicon resins, polysiloxane resins and the like. When a thermosetting resin is used, a curing agent such as a crosslinking agent or polymerization initiator, or a polymerization promoter, solvent, viscosity modifier or the like may also be used therewith if necessary.

### [Curable Binder Component]

The curable binder component may be a compound with no more than two reactive functional groups c, and specifically there may be mentioned polyethyleneglycol diacrylate, triethyleneglycol diacrylate, ethyleneglycol diacrylate, polypropyleneglycol diacrylate, polyether diacrylate, dipropyleneglycol diacrylate, bisphenol A-type epoxy acrylate, bisphenol F-type epoxy acrylate, 1,6-hexanediol diacrylate, neopentyl glycol diacrylate, 1,4-butanediol diacrylate, 1,9-nonanediol diacrylate, trimethylolpropane diacrylate, tricyclodecanedimethanol diacrylate, pentaerythritol diacrylate monostearate, isocyanuric acid diacrylate and the like.

It is preferably a (meth)acrylate containing a polar group (OH or the like) with a number-average molecular weight of no greater than 1000, such as pentaerythritol triacrylate or dipentaerythritol tetraacrylate, for example.

Such compounds have excellent dispersibility for reactive inorganic fine particles A that have been sufficiently hydrophobized, while also creating a dense network structure with short distances between crosslinking points, and therefore the excluded volume effect allows the hydrophilic fine particles B present near the cured film surface to become efficiently maldistributed on the surface (within 300 nm from the air interface).

### [Polymer Component]

The “polymer component” may be a “macromer” having a reactive group at one end or at both ends.

### <Other Components>

As solvents there may be mentioned alcohols such as methanol, ethanol, isopropyl alcohol, butanol, isobutyl alcohol, methyl glycol, methyl glycol acetate, methylcellosolve, ethylcellosolve and butylcellosolve; ketones such as acetone, methyl ethyl ketone, methyl isobutyl ketone, cyclohexanone and diacetone alcohol; esters such as methyl formate, methyl acetate, ethyl acetate, ethyl lactate and butyl acetate; nitrogen-containing compounds such as nitromethane, N-methylpyrrolidone and N,N-dimethylformamide; ethers such as diisopropyl ether, tetrahydrofuran, dioxane and dioxolane; halogenated hydrocarbons such as methylene chloride, chloroform, trichloroethane and tetrachloroethane; and other solvents such as dimethyl sulfoxide and propylene carbonate; as well as mixtures of the foregoing. As more preferred solvents there may be mentioned methyl acetate, ethyl acetate, butyl acetate and methyl ethyl ketone.

The curable resin composition for a hard coat layer according to the invention may also contain an antistatic agent and an anti-glare agent. Various additives such as reactive or non-reactive leveling agents and sensitizing agents may also be added. Including an antistatic agent and/or anti-glare agent can further impart an antistatic property and/or anti-glare property to the curable resin composition for a hard coat layer according to the invention.

### <Preparation of Resin Composition>

The curable resin composition for a hard coat layer according to the invention is prepared by mixing and dispersing the aforementioned components by an ordinary preparation method. The mixing and dispersion may be carried out using a paint shaker or bead mill. When the reactive inorganic fine particles A and hydrophilic fine particles B are dispersed in a solvent, the other components including the aforementioned curable reactive matrix and solvent are added to the dispersion as appropriate, and mixed and dispersed therewith.

There are no particular restrictions on the solid concentration of the curable resin composition for a hard coat layer according to the invention, but normally it will be in the range of 5 wt %-40 wt % and most preferably it is in the range of 15 wt %-30 wt %.

### II. Hard Coat Film

The hard coat film of the invention is characterized by comprising at least a hard coat layer composed of the cured product of a curable resin composition for a hard coat layer according to the invention as described above, on a transparent base film, optionally with one or more resin layers further laminated thereover.

According to the invention, a hard coat layer comprising the cured product of a curable resin composition for a hard coat layer according to the invention is formed on a transparent base film, so that it is possible to provide a hard coat film having the desired irregular shape on the hard coat layer surface, without impairing the transparency and mar-proofness of the hard coat layer.

The hard coat film of the invention is also characterized in that the hydrophilic fine particles B in the hard coat layer form irregularities on the hard coat layer surface, of which the raised sections have heights greater than 3 nm and no greater than 50 nm, and the spacings between the raised sections are 50 nm-5 μm.

According to the invention wherein the desired irregular shape is formed in the hard coat layer surface, it is possible to prevent sticking between the surface of the hard coat layer side of the hard coat film and the surface of the base film side of the hard coat film when the hard coat film is a long roll that has been continuously taken up into the form of a continuous tape.

FIG. 2 is a cross-sectional view showing an example of a hard coat film according to the invention. For the ease of illustration, FIG. 2 shows the thickness direction (vertical direction in the drawing) magnified over the dimension in the direction of the plane (horizontal direction in the drawing). In the example shown in FIG. 2, a hard coat layer 2 composed of the cured product of a curable resin composition for a hard coat layer according to the invention is laminated on one side of the transparent base film 1, and an irregular shape is formed on the surface of the hard coat layer 2.

Each of the layers of the hard coat film of the invention will now be described in order.

### <Transparent Base Film>

The material of the transparent base film is not particularly restricted, and any ordinary material conventionally used for hard coat films may be employed, although materials composed mainly of cellulose acylate, cycloolefin polymers, acrylate-based polymers, or polyesters are preferred. Here, “composed mainly of” means that the component has the highest content among the constituent components of the base.

As specific examples of cellulose acylates, there may be mentioned cellulose triacetate, cellulose diacetate and cellulose acetate butyrate. As examples of cycloolefin polymers, there may be mentioned norbornane-based copolymers, monocyclic olefin-based copolymers, cyclic conjugated diene-based polymers, vinylalicyclic hydrocarbon-based copolymer resins and the like, and more specifically, ZEONEX or ZEONOR (norbornane-based resin) by Zeon Corp., SUMILITE FS-1700 by Sumitomo Bakelite Co., Ltd., ARTON (modified norbornane-based resin) by JSR Corp., APEL (cyclic olefin copolymer) by Mitsui Chemicals, Inc., Topas (cyclic olefin copolymer) by Ticona and the OPTOREZ OZ-1000 series (alicyclic acrylic resins) by Hitachi Chemical Co., Ltd. As specific examples of acrylate-based polymers there may be mentioned methyl poly(meth)acrylate, ethyl poly(meth)acrylate and methyl (meth)acrylate-butyl (meth)acrylate copolymer. Here, “(meth)acrylic” includes acrylic, methacrylic and mixtures of both. As specific examples of polyesters there may be mentioned polyethylene terephthalate and polyethylene naphthalate.

The thickness of the transparent base film is from 20 μm to 300 μm, and preferably from 30 μm to 200 μm. During formation of the hard coat layer on the transparent base film according to the invention, the transparent base may be subjected to physical treatment such as corona discharge treatment or oxidation treatment, or coating with a coating agent such as an anchoring agent or primer, in order to improve the adhesive property.

### <Hard Coat Layer>

The hard coat layer used for the invention comprises components of the curable reactive matrix that when cured forms a matrix for the hard coat layer, the essential components being the reactive inorganic fine particles A to impart a hard coat property, the hydrophilic fine particles B that form an irregular shape on the hard coat layer surface to reduce sticking of the surface and the binder component C to impart adhesiveness to the base and the adjacent layer, and the hard coat layer is formed on the transparent base film, either directly or via another layer.

A “hard coat layer” is generally one that exhibits a hardness of “H” or greater in the pencil hardness test specified by JIS K5600-5-4 (1999). The hardness is a value that depends on the type and thickness of the base film and is not restricted, being appropriately selected for the intended purpose and required performance, but the hard coat layer used for the invention preferably has a hardness of 2H or greater and especially 3H or greater in the aforementioned pencil hardness test. The film thickness of the hard coat layer is preferably from 1 μm to 50 μm from the viewpoint of mar-proofness, and more preferably it is from 5 μm to 30 μm and especially from 5 μm to 20 μm.

According to the invention, the heights of the raised sections in the irregular shape on the hard coat layer surface are preferably from 3 nm to 50 nm, and most preferably from 5 nm to 20 nm. At less than 3 nm the effect may not be sufficient to prevent sticking, while at greater than 50 nm the transparency may be impaired. The spacings between raised sections are preferably 50 nm-5 μm. If the spacing is less than 50 nm the transparency may be impaired, and if it is greater than 5 μm it will be difficult to obtain a sufficient effect of preventing sticking.

### <Other Layers>

The hard coat film of the invention is composed basically of a transparent base film and a hard coat layer, as explained above. However, one or more of the following types of layers may also be included in addition to the hard coat layer of the invention, in order to add to the function or potential uses of the hard coat film. A medium refractive index layer or high refractive index layer may also be included.

### (1) Antistatic Layer

An antistatic layer contains an antistatic agent and a resin. The thickness of the antistatic layer is preferably about 30 nm-1 μm.

As specific examples of antistatic agents, there may be mentioned quaternary ammonium salts, pyridinium salts and various cationic compounds with cationic groups such as primary-tertiary amino groups, anionic compounds with anionic groups such as sulfonate groups, sulfate groups, phosphate ester groups and phosphonate groups, amino acid-based and aminosulfuric acid ester-based amphoteric compounds, amino alcohol-based, glycerin-based and polyethylene glycol-based nonionic compounds, organometallic compounds such as tin and titanium alkoxides, and metal chelate compounds such as acetylacetonate salts of the same, as well as compounds obtained by high molecularization of the compounds mentioned above. The antistatic agent may also be a polymerizable compound, such as a monomer or oligomer that has a tertiary amino group, quaternary ammonium or metal chelate group and is polymerizable by ionizing radiation, or an organometallic compound such as a coupling agent with functional groups that are polymerizable by ionizing radiation.

Conductive fine particles may also be mentioned as examples of the aforementioned antistatic agent. Metal oxides may be mentioned as specific examples of conductive fine particles. As such metal oxides there may be mentioned ZnO (refractive index: 1.90; values in parentheses hereunder represent refractive indexes), CeO₂ (1.95), Sb₂O₂ (1.71), SnO₂ (1.997), indium tin oxide, commonly abbreviated as ITO (1.95), In₂O₃ (2.00), Al₂O₃ (1.63), antimony-doped tin oxide (ATO, 2.0), aluminum-doped zinc oxide (AZO, 2.0) and the like. The mean particle size of the conductive fine particles is preferably 0.1 nm-0.1 μm. Within this range, a composition is obtained that exhibits virtually no haze when the conductive fine particles are dispersed in the binder, and that can form a highly transparent film with satisfactory total light transmittance.

Specific examples of resins that may be used in the antistatic layer include thermoplastic resins, thermosetting resins and photocuring resins or photocuring compounds (including organic reactive silicon compounds). Although thermoplastic resins may also be used for such resins, thermosetting resins are more preferred, and photocuring compositions containing photocuring resins or photocuring compounds are even more preferred.

Photocuring compositions include suitable mixtures of prepolymers, oligomers and/or monomers having polymerizable unsaturated groups or epoxy groups in the molecule.

Examples of prepolymers, oligomers and monomers among photocuring compositions include the same ones mentioned above for the hard coat layer.

For most purposes, one or more monomers may be combined in the photocuring composition if necessary, and in order to impart ordinary coating suitability to the photocuring composition, the prepolymer or oligomer is preferably used at 5 wt % or greater and the monomer and/or polythiol compound at no greater than 95 wt %.

### (2) Low Refractive Index Layer

The low refractive index layer may be a thin film of about 30 nm-1 μm, composed of a resin containing silica or magnesium fluoride, a low refractive index fluorine-based resin, or a fluorine-based resin containing silica or magnesium fluoride, and having a refractive index of no greater than 1.46, or a thin film obtained by chemical vapor deposition or physical deposition of silica or magnesium fluoride. Resins other than fluorine resins may be the same resins used to form the antistatic layer.

The low refractive index layer is more preferably composed of a silicone-containing vinylidene fluoride copolymer. Specifically, the silicone-containing vinylidene fluoride copolymer is obtained by copolymerizing, as the starting material, a monomer composition containing 30-90% vinylidene fluoride and 5-50% hexafluoropropylene (all percentages hereunder are based on weight), and it is a resin composition comprising 100 parts of a fluorine-containing copolymer with a fluorine content of 60-70% and 80-150 parts of a polymerizable compound with an ethylenic unsaturated group; the resin composition is used to form a low refractive index layer which is a thin film with a film thickness of no greater than 200 nm, exhibiting mar-proofness and having a refractive index of less than 1.60 (preferably no greater than 1.46).

The low refractive index layer may alternatively be composed of a SiO₂ thin film, which is formed by vapor deposition, sputtering or plasma CVD, or by a method of forming a SiO₂ gel film from a sol solution containing a SiO₂ sol. The low refractive index layer may also be formed of other materials such as a MgF₂ thin film instead of SiO₂, but a SiO₂ thin film is preferably used from the standpoint of high adhesiveness with the lower layer.

According to a preferred embodiment of the low refractive index layer of the invention, it is preferred to use “fine particles with voids”.

Fine particles with voids can help maintain the low refractive index layer strength while lowering the refractive index. The term “fine particles with voids” refers to fine particles having a structure with the fine particle interiors filled with gas and/or a porous structure containing a gas, and such fine particles have lower refractive indexes compared to the refractive indexes of the original fine particles, in inverse proportion to the gas content of the fine particles. The invention also encompasses fine particles that can form a nanoporous structure in at least part of the interior and/or surface, by the form, structure, aggregated state and dispersed state of the fine particles in the coated film interior.

The mean particle sizes of the fine particles with voids are from 5 nm to 300 nm, preferably the lower limit being 8 nm or greater and the upper limit being 80 nm or less, and even more preferably the lower limit being 10 nm or greater and the upper limit being 80 nm or less. A mean particle size of the fine particles within these ranges can impart the low refractive index layer with excellent transparency.

### (3) Antifouling Layer

According to a preferred embodiment of the invention, an antifouling layer may be provided to prevent fouling of the low refractive index layer surface. The antifouling layer can further improve the antifouling property and mar-proofness of the hard coat film.

As specific examples of antifouling agents, there may be mentioned fluorine-based compounds and/or silicon-based compounds that have low compatibility with photocuring resin compositions having fluorine atoms in the molecule and are considered difficult to add to low refractive index layers, and fluorine-based compounds and/or silicon-based compounds that are compatible with photocuring resin compositions and fine particles having fluorine atoms in the molecule.

The process for production of a hard coat film of the invention will now be explained.

First, a transparent base film is prepared, as described above in the description of the hard coat film. A curable resin composition for a hard coat layer according to the invention is then prepared. The obtained curable resin composition for a hard coat layer is coated onto the transparent base film and dried.

The coating method is not particularly restricted so long as it allows even coating of the hard coat layer-forming resin composition on the transparent base film surface, and various methods may be employed Such as spin coating, dipping, spraying, die coating, bar coating, roll coating, meniscus coating, flexographic printing, screen printing, bead coating and the like.

The coating coverage on the transparent base film will differ depending on the performance required for the obtained hard coat film, but the post-drying coverage is preferably in the range of 1 g/m²-30 g/m² and especially in the range of 5 g/m²-25 g/m². In terms of the film thickness, this is preferably in the range of 1 μm-25 μm and especially in the range of 5 μm-20 μm. The coated film thickness may be measured by determining the total film thickness using a contact film thickness meter, and subtracting the value measured for the film thickness of the transparent base film alone.

The method of drying may be, for example, drying under reduced pressure or heat drying, or even a combination of such drying methods. For example, when the solvent is a ketone-based solvent, a drying step may be carried out at a temperature in the range of usually from room temperature to 80° C. and preferably 40° C.-60° C., for a period of from about 20 seconds-3 minutes and preferably 30 seconds-1 minute.

The reactive inorganic fine particles A and hydrophilic fine particles B evenly dispersed in the curable resin composition for a hard coat layer become maldistributed during the drying step, specifically with the reactive inorganic fine particles A maldistributed near the interface on the transparent base film side and the hydrophilic fine particles B maldistributed near the interface on the side opposite the transparent base film side.

The coated film obtained by coating and drying the curable resin composition for a hard coat layer is irradiated and/or heated, depending on the reactive functional groups in the curable resin composition, to cure the coated film, and thereby cause crosslinked bonding between the reactive functional group a of the reactive inorganic fine particles A and the reactive functional group c of the binder component C among the constituent components of the curable resin composition, to form a hard coat layer composed of the cured product of the curable resin composition. The hydrophilic fine particles B among the constituent components of the curable resin composition become anchored, forming a desired irregular shape on the surface of the hard coat layer to obtain a hard coat film according to the invention.

The irradiation may be carried out using ultraviolet rays, visible light, an electron beam, ionizing radiation or the like. In the case of ultraviolet curing, ultraviolet rays emitted from a light ray such as a ultra-high-pressure mercury lamp, high-pressure mercury lamp, low-pressure mercury lamp, carbon arc, xenon arc or metal halide lamp are used. The exposure dose from the energy ray source may be approximately 50-5000 mJ/cm² as the cumulative exposure dose at an ultraviolet wavelength of 365 nm.

With ultraviolet curing, curing of the surface is often insufficient when oxygen is present. Depending on the combination of materials used, insufficient curing of the surface results in curing from the interior, thus increasing the extent to which the hydrophilic fine particles B are pushed out from the interior toward the surface, in which case the raised sections become excessively high and whitening may result. The increased heights of the raised sections satisfactorily prevent contact sticking between mirror surfaces, but impair the saponification durability, mar-proofness and optical characteristics. More stable curing can, therefore, be accomplished if it is carried out while purging with nitrogen, in order to minimize oxygen inhibition.

In the case of heating, it will generally be carried out at a temperature of 40° C.-120° C. The reaction may also be conducted by allowing the film to stand at room temperature (25° C.) for 24 hours or longer.

The anti-sticking effect of the hard coat film is exhibited both with long film rolls such as used in roll-to-roll processes and with sheet films, but according to the invention, an excellent anti-sticking effect is exhibited even against strong sticking near the roll center of long films that have been wound into rolls. The hard coat film of the invention is therefore suitable for use as a long film roll that has been continuously taken up in the form of a continuous tape.

The invention is not limited to the embodiments described above. This mode was explained merely for illustration, and any mode that has a construction essentially identical in terms of the technical concept described in the claims of the present invention and exhibits the same working effect is also encompassed by the technical scope of the invention.

### EXAMPLES

### Examples

The present invention will now be explained in greater detail using examples. However, it is to be understood that the invention is not restricted by the examples. The “parts” referred to throughout the examples are based on weight, unless otherwise specified.

### Preparation Example 1

### Preparation of Reactive Inorganic Fine Particles A(1)

### (1) Removal of Surface Adsorbed Ions

Water-dispersed colloidal silica with a mean particle size of 50 nm (SNOWTEX XL, trade name of Nissan Chemical Industries, Ltd., pH 9-10) was subjected to ion exchange for 3 hours using 400 g of a cation-exchange resin (DIAION SK1B, product of Mitsubishi Chemical Corp.), and then 200 g of an anion exchange resin (DIAION SA20A, product of Mitsubishi Chemical Corp.) was used for 3 hours' ion exchange, followed by washing to obtain an aqueous dispersion of inorganic fine particles with a solid concentration of 40 wt %.

The Na₂O content of the inorganic fine particle aqueous dispersion was 7 ppm for inorganic fine particle.

### (2) Surface Treatment (Introduction of Monofunctional Monomer)

To 10 g of the inorganic fine particle aqueous dispersion treated in (1) above were added 150 ml of isopropanol, 4.0 g of 3,6,9-trioxadecanoic acid and 4.0 g of methacrylic acid, and the mixture was stirred for 30 minutes.

The obtained mixture was stirred while heating at 60° C. for 5 hours, to obtain an inorganic fine particle dispersion having methacryloyl groups introduced on the fine particle surfaces. The distilled water and isopropanol were distilled off from the obtained inorganic fine particle dispersion using a rotary evaporator, and methyl ethyl ketone was added to avoid drying for a final water or isopropanol residue of 0.1 wt %, to obtain a silica-dispersed methyl ethyl ketone solution with a solid content of 50 wt %.

The reactive inorganic fine particles A(1) obtained in this manner were measured using a Microtrac particle size analyzer by Nikkiso Co., Ltd. and were found to have a mean particle size of d₅₀=50 nm.

### Preparation Example 2

### Preparation of Reactive Inorganic Fine Particles A(2)

Reactive inorganic fine particles A(2) were prepared by the same method as Preparation Example 1, except that water-dispersed colloidal silica with a mean particle size of 80 nm (SNOWTEX ZL, trade name of Nissan Chemical Industries, Ltd., pH 9-10) was used. The reactive inorganic fine particles A(2) obtained in this manner were measured using a Microtrac particle size analyzer by Nikkiso Co., Ltd. and were found to have a mean particle size of d₅₀=80 nm.

### Preparation Example 3

### Preparation of Reactive Inorganic Fine Particles A(3)

### (1) Removal of Surface Adsorbed Ions

An aqueous dispersion of inorganic fine particles with the surface adsorbed ions removed was obtained in the same manner as Preparation Example 1.

### (2) Surface Treatment (Introduction of Polyfunctional Monomer)

Surface treatment was carried out by the same method as Preparation Example 1, except that the methacrylic acid in Preparation Example 1 was changed to dipentaerythritol pentaacrylate (SR399, trade name of Sartomer Co., Inc.).

The reactive inorganic fine particles A(3) obtained in this manner were measured using the aforementioned particle size analyzer and were found to have a mean particle size of d₅₀=52 nm.

### Preparation Example 4

### Preparation of Reactive Inorganic Fine Particles A(4)

A silica sol with a mean particle size of 45 nm (organosilica sol, OSCAL, trade name of Catalysts & Chemicals Industrial Co., Ltd., isopropyl alcohol dispersion) was subjected to solvent exchange from isopropyl alcohol to methyl isobutyl ketone using a rotary evaporator, to obtain a dispersion containing 20 wt % silica fine particles. Next, 20 parts by weight of 3-methacryloxypropylmethyldimethoxysilane was added to 100 parts by weight of the methyl isobutyl ketone dispersion, and the mixture was heat treated at 50° C. for 1 hour to obtain methyl isobutyl ketone dispersion A(4) containing 20 wt % surface-treated hollow silica fine particles.

The reactive inorganic fine particles A(4) obtained in this manner were measured using a Microtrac particle size analyzer by Nikkiso Co., Ltd. and were found to have a mean particle size of d₅₀=45 nm.

### Preparation Example 5

### Preparation of Reactive Inorganic fine particles A(5)

After adding 20.6 parts of isophorone diisocyanate dropwise to a solution comprising 7.8 parts of mercaptopropyltrimethoxysilane and 0.2 part of dibutyltin dilaurate at 50° C. for 1 hour while stirring in dry air, the mixture was stirred at 60° C. for 3 hours. To this was added dropwise 71.4 parts of pentaerythritol triacrylate over a period of 1 hour at 30° C., and then the mixture was heated and stirred at 60° C. for 3 hours to obtain compound (1).

A mixture of 88.5 parts (26.6 parts solid content) of Methanol-Silica sol (trade name of product of Nissan Chemical Industries, Ltd., colloidal silica dispersion with methanol solvent (number-mean particle size: 50 nm, silica concentration: 30%)), 8.5 parts of compound (1) synthesized as described above and 0.01 part of p-methoxyphenol, was stirred at 60° C. for 4 hours under a nitrogen stream. Next, 3 parts of methyltrimethoxysilane was added as compound (2) to the mixture and stirring was continued at 60° C. for 1 hour, and then 9 parts of methyl orthoformate ester was added and the mixture was heated and stirred at the same temperature for 1 hour to obtain crosslinkable inorganic fine particles. The reactive inorganic fine particles A(5) obtained in this manner were measured using the aforementioned particle size analyzer and were found to have a mean particle size of d₅₀=63 nm.

### Preparation Example 6

### Preparation of Reactive Inorganic Fine Particles A(6)

A silica sol with a mean particle size of 5 nm (organosilica sol, OSCAL, trade name of Catalysts & Chemicals Industrial Co., Ltd., isopropyl alcohol dispersion) was subjected to solvent exchange from isopropyl alcohol to methyl isobutyl ketone using a rotary evaporator, to obtain a dispersion containing 20 wt % silica fine particles. Next, 20 parts by weight of 3-methacryloxypropylmethyldimethoxysilane was added to 100 parts by weight of the methyl isobutyl ketone dispersion, and the mixture was heat treated at 50° C. for 1 hour to obtain methyl isobutyl ketone dispersion A(4) containing 20 wt % surface-treated hollow silica fine particles.

The reactive inorganic fine particles A(4) obtained in this manner were measured using a Microtrac particle size analyzer by Nikkiso Co., Ltd. and were found to have a mean particle size of d₅₀=6 nm.

### Example 1

### (1) Preparation of Curable Resin Composition for Hard Coat Layer

The following components were mixed and adjusted to a solid content of 50 wt % with the solvent, to prepare a curable resin composition for a hard coat layer.

### <Composition of Curable Resin Composition for Hard Coat Layer>

UV1700B (trade name of Nippon Synthetic Chemical Industry Co., Ltd., decafunctional, molecular weight: 2,000): 70 parts by weight (solid content)

Reactive inorganic fine particles A(1) of Preparation Example (1) (mean particle size: 50 nm): 30 parts by weight (solid content)

Methyl ethyl ketone: 100 parts by weight

Hydrophilic fine particles B silica sol (IPA-ST-ZL, trade name of Nissan Chemical Industries, Ltd., mean particle size: 100 nm): 1 part by weight

IRGACURE 184 (trade name of Ciba Specialty Chemicals Co., Ltd., radical polymerization initiator): 0.4 part by weight

### (2) Formation of Hard Coat Film

The curable resin composition for a hard coat layer prepared in (1) was coated onto a 80 μm cellulose triacetate film as the transparent base film, to a wet weight of 40 g/m² (dry weight: 20 g/m², approximately 15 μm). After drying at 50° C. for 30 seconds, it was exposed to 200 mJ/cm² ultraviolet rays to form a hard coat film for Example 1.

### Example 2-Example 16

Hard coat films were formed by blending components for the curable resin composition for a hard coat layer, UV1700B, methyl ethyl ketone and IRGACURE 184 in the same amounts and the reactive inorganic fine particles A and hydrophilic fine particles B (silica) in the amounts listed in Table 1 below. In some cases, the hydrophilic fine particles B used were silica (trade name: SEAHOSTAR KE-P30, product of Nippon Shokubai Co., Ltd.) with a mean particle size of d₅₀=250 nm.

### Example 17

A hard coat film was obtained in the same manner as Example 1, except for using dipentaerythritol pentaacrylate (hexafunctional) for binder component C.

### Example 18

A hard coat film was obtained in the same manner as Example 1, except for using pentaerythritol triacrylate (trifunctional) for binder component C.

### Example 19

A hard coat film was obtained in the same manner as Example 1, except for using BEAMSET 371 (trade name of Arakawa Chemical Industries, Ltd., greater than 50-functional) for binder component C.

### Example 20

A hard coat film was obtained in the same manner as Example 1, except that 5 parts by weight of hydrophilic fine particles B was added for production of the hard coat film of Example 11.

TABLE 1

| | | | | | | | | Height of | Spacing of | |
|---|---|---|---|---|---|---|---|---|---|---|
| | | | | | | | | raised | raised | |
| | Reactive | Hydrophilic | Hydrophilic | | | | | sections in | sections in | |
| | inorganic | fine | fine | | Pencil | | | surface | surface | Indentation |
| | fine | particles B | particles B | Pencil | hardness | | | irregularities | irregularities | depth |
| Example | particles A | (nm) | addition | hardness | evaluation | Haze | Sticking | (nm) | (μm) | (μm) |
| 1 | (1) | 100 | 1 part by | 4 H | ⊚ | 0.3 | ⊚ | 3-10 | 1 | 0.6 |
| | | | wt. | 1 scratch | | | | | | |
| 2 | (1) | 100 | 0.1 part by | 4 H | ⊚ | 0.3 | ⊚ | 3-10 | 0.7 | 0.6 |
| | | | wt. | 1 scratch | | | | | | |
| 3 | (1) | 250 | 1 part by | 4 H | ⊚ | 0.4 | ⊚ | 3-10 | 1.3 | 0.7 |
| | | | wt. | 1 scratch | | | | | | |
| 4 | (1) | 250 | 0.1 part by | 4 H | ⊚ | 0.4 | ◯ | 3-10 | 80 nm | 0.8 |
| | | | wt. | 1 scratch | | | | | | |
| 5 | (2) | 100 | 0.1 part by | 4 H | ⊚ | 0.3 | ⊚ | 3-10 | 60 nm | 0.6 |
| | | | wt. | 1 scratch | | | | | | |
| 6 | (2) | 250 | 0.1 part by | 4 H | ⊚ | 0.4 | ◯ | 3-10 | 1.6 | 0.6 |
| | | | wt. | 0 scratches | | | | | | |
| 7 | (3) | 100 | 0.1 part by | 4 H | ⊚ | 0.3 | ⊚ | 3-10 | 2 | 0.6 |
| | | | wt. | 1 scratch | | | | | | |
| 8 | (3) | 250 | 0.1 part by | 4 H | ⊚ | 0.4 | ◯ | 3-10 | 2.5 | 0.4 |
| | | | wt. | 0 scratches | | | | | | |
| 9 | (4) | 100 | 0.1 part by | 4 H | ⊚ | 0.3 | ⊚ | 3-10 | 70 nm | 0.5 |
| | | | wt. | 0 scratches | | | | | | |
| 10 | (4) | 250 | 0.1 part by | 4 H | ⊚ | 0.3 | ◯ | 3-10 | 0.1 | 0.4 |
| | | | wt. | 0 scratches | | | | | | |
| 11 | (5) | 100 | 1 part by | 4 H | ⊚ | 0.3 | ⊚ | 3-10 | 75 | 0.4 |
| | | | wt. | 0 scratches | | | | | | |
| 12 | (5) | 100 | 0.1 part by | 4 H | ⊚ | 0.3 | ⊚ | 3-10 | 1.2 | 0.5 |
| | | | wt. | 0 scratches | | | | | | |
| 13 | (5) | 250 | 1 part by | 4 H | ⊚ | 0.4 | ⊚ | 3-10 | 1.1 | 0.4 |
| | | | wt. | 0 scratches | | | | | | |
| 14 | (5) | 250 | 0.1 part by | 4 H | ⊚ | 0.4 | ⊚ | 3-10 | 1.6 | 0.4 |
| | | | wt. | 0 scratches | | | | | | |
| 15 | (6) | 100 | 0.1 part by | 4 H | ⊚ | 0.3 | ◯ | 3-10 | 50 | 0.7 |
| | | | wt. | 1 scratch | | | | | | |
| 16 | (6) | 250 | 0.1 part by | 4 H | ⊚ | 0.3 | ◯ | 3-10 | 0.1 | 0.6 |
| | | | wt. | 1 scratch | | | | | | |
| 17 | (5) | 100 | 1 part by | 4 H | ⊚ | 0.3 | ◯ | 3-10 | 0.3 | 0.5 |
| | | | wt. | 0 scratches | | | | | | |
| 18 | (5) | 100 | 1 part by | 4 H | ⊚ | 0.3 | ◯ | 3-10 | 0.5 | 1 |
| | | | wt. | 1 scratch | | | | | | |
| 19 | (5) | 100 | 1 part by | 4 H | ⊚ | 0.3 | ◯ | 30 | 4 | 0.9 |
| | | | wt. | 1 scratch | | | | | | |
| 20 | (5) | 100 | 5 parts by | 4 H | ◯ | 0.5 | ◯ | 40 | 3.2 | 1.3 |
| | | | wt. | 2 scratches | | | | | | |

### Comparative Example 1

A hard coat film was obtained in the same manner as Example 1, except that 51 parts by weight of hydrophilic fine particles B with a mean particle size of d₅₀=40 nm (MEK-ST-L, trade name of Nissan Chemical Industries, Ltd.) was used instead of the reactive inorganic fine particles A for preparation of the hard coat film of Example 1.

### Comparative Example 2

A hard coat film was obtained in the same manner as Example 1, except that only the reactive inorganic fine particles A obtained in Preparation Example 5 were used for production of the hard coat film of Example 11.

### Comparative Example 3

A hard coat film was obtained in the same manner as Example 1, except that 1 part by weight of silica beads with a mean particle size of d₅₀=500 nm (SEAHOSTAR KE-P50, trade name of Nippon Shokubai Co., Ltd.) was used instead of the hydrophilic fine particles B, for preparation of the hard coat film of Example 11.

### Comparative Example 4

A hard coat film was obtained in the same manner as Example 1, except that 1 part by weight of urethane beads with a mean particle size of d₅₀=300 nm (product of Negami Chemical Industrial Co., Ltd.) was used instead of the hydrophilic fine particles B, for preparation of the hard coat film of Example 11.

### Comparative Example 5

### Hydrophilic Fine Particle B Content Above Upper Limit

A hard coat film was obtained in the same manner as Example 1, except that 6 parts by weight of hydrophilic fine particles B was added for preparation of the hard coat film of Example 11.

### Comparative Example 6

Mean primary particle size above upper limit

### Preparation Example 7

### Preparation of Reactive Inorganic Fine Particles A(7)

Reactive inorganic fine particles A(7) were prepared by the same method, except that IPA-dispersed colloidal silica with a mean particle size of d₅₀=100 nm (trade name: IPA-ST-ZL, product of Nissan Chemical Industries, Ltd., silica concentration: 300) was used as the silica sol in Preparation Example 5.

A hard coat film was obtained in the same manner as Example 1, except that only the reactive inorganic fine particles A(7) were used for production of the hard coat film of Example 11.

### Comparative Example 7

A hard coat film was obtained in the same manner as Example 1, except that a mixed resin comprising urethane acrylate (UX8101D by Nippon Kayaku Co., Ltd., bifunctional, weight-average molecular weight: ≧5000) and pentaerythritol triacrylate (trifunctional) at 1:1 was used for the binder component C for preparation of the hard coat film of Example 20.

The sample used for the indentation depth test was a separately prepared hard coat film with a dry film thickness of 20 μm.

The results for Comparative Examples 1-7 are shown in Table 2 below.

TABLE 2

| | | | | | | | | Height of | Spacing of | |
|---|---|---|---|---|---|---|---|---|---|---|
| | Reactive | | | | | | | raised | raised | |
| | inorganic | Hydrophilic | Hydrophilic | | | | | sections in | sections in | |
| | fine | fine | fine | | Pencil | | | surface | surface | Indentation |
| Comp. | particles | particles B | particles B | Pencil | hardness | | | irregularities | irregularities | depth |
| Ex. | A | (nm) | addition | hardness | evaluation | Haze | Sticking | (nm) | (μm) | (μm) |
| 1 | — | 40 | 51 parts by | 3 H | X | 0.3 | X | 30 | 35 nm | 1.7 |
| | | | wt. | 5 scratches | | | | | | |
| 2 | 63 nm | — | — | 4 H | ⊚ | 0.3 | X | 3≧ | 8 | 0.4 |
| | | | | 1 scratch | | | | | | |
| 3 | (5) | 500 | 1 part by | 3 H | X | 1.0 | ◯ | 80 | 7.8 | 1.6 |
| | | | wt. | multiple | | | | | | |
| | | | | scratches | | | | | | |
| 4 | (5) | 300 | 1 part by | 3 H | X | 0.3 | X | 3≧ | 6.3 | 1.5 |
| | | | wt. | multiple | | | | | | |
| | | | | scratches | | | | | | |
| 5 | (5) | 100 | 6 parts by | 3 H | X | 0.7 | ◯ | 50 | 90 nm | 1.6 |
| | | | wt. | multiple | | | | | | |
| | | | | scratches | | | | | | |
| 6 | (7) | 100 | 1 part by | 3 H | X | 1.3 | X | 60 | 2.5 | 1.6 |
| | | | wt. | multiple | | | | | | |
| | | | | scratches | | | | | | |
| 7 | (5) | 100 | 5 parts by | 2 H | X | 0.5 | X | 40 | 1.3 | 1.8 |
| | | | wt. | multiple | | | | | | |
| | | | | scratches | | | | | | |

### [Evaluation Methods]

The following properties were evaluated for the examples and comparative examples. The results are shown in Tables 1 and 2. Except for evaluation of the indentation depth, the samples used for the evaluation were obtained with the same material, film thickness and production conditions for all of the examples and comparative examples to allow comparison under consistent conditions.

### (1) Pencil Hardness

The pencil hardness of the hard coat layer surface of the obtained hard coat film was evaluated according to JIS K5600-5-4 (1999). Specifically, a 2H-4H pencil was used to draw 5 lines with a load of 500 g, and then the presence of scratches in the hard coat layer was visually observed and evaluated on the following scale.

### <Evaluation Scale>

⊚: 0-1 scratches
◯: 2-3 scratches
X: 4-5 scratches

(2) Haze

A HM-150 Hazemeter (product of Murakami Color Research Laboratory Co., Ltd.) was used for measurement by the transmission method according to JIS-K-7105.

(3) Sticking

The hard, coat layer-formed surface and film surface were placed together, subjected to a 40 kg/cm² load and allowed to stand for 20 minutes, and then evaluated.

### <Evaluation Scale>

⊚: No sticking
◯: Partial sticking
X: Complete sticking

### (4) Irregular Shape Height and Raised Section Spacing

A NewView6200 non-contact three-dimensional surface shape and roughness analyzer by Zygo Corp. was used to observe the surfaces of hard coat layers formed according to the examples and comparative examples described above. FIG. 4 shows an example of an observation image. As seen in FIG. 4 (where the arrows indicate cut sections), 5 cut sections are arbitrarily selected, a surface roughness curve is plotted for each section (as in FIG. 5, for example), and the heights and spacing between any two raised sections are determined. Data for the raised section heights and raised section spacings are obtained for a total of 10 points, and the average value is calculated. A perspective plot is shown in FIG. 6 to illustrate the surface irregularities more clearly.

The raised section heights are preferably from 3 nm and to 50 nm, while the spacings between raised sections are preferably 50 nm-5 μm. The raised section heights and raised section spacings may be measured with an atomic force microscope. In this case as well, the average value is calculated from the observation screen by the same method described above.

### (5) Indentation Depth of Hard Coat Layer

A micro-indentation hardness tester by Fischer Instruments, KK. (PICODENTOR HM500, ISO14577-1) was used to prepare measuring samples for each of the examples and comparative examples, in the following manner, and the indentation depth (μm) under an indentation load of 10 mN was measured.

The curable resin composition for a hard coat layer, diluted with an appropriate solvent and mixed with a UV initiator at 3% of the resin solid weight, was applied onto a 40 μm TAC (TAC corresponding to KC4UYW by Konica Minolta Holdings, Inc.) using a Meyer bar, and after drying off the solvent, it was cured by UV rays at approximately 120 mJ to produce a sample film with a hard coat layer film thickness of 10-20 μm. The reason for the film thickness range is so that, since it is important for the indentation depth of the indenter used for the hardness test to be about 10% of the coating thickness, the film thickness can be appropriately adjusted for the sample film if the measured indentation depth exceeds this range.

The surface of the measuring sample is preferably flat. Therefore, when it is difficult to achieve surface flatness with the resin alone, a leveling agent may be added at 0.1%-3% of the resin weight. In order to guarantee a flat measuring sample, a 2 cm-square sample film was bonded onto 1 mm-thick glass using a superglue (AronAlpha). Since the flatness may be affected with excess AronAlpha, the minimum amount was used to initially bond the sample, and then the flat glass was placed on the hard coat side, sandwiching the sample film, and a 500 g weight was placed thereover and allowed to stand for 24 hours, after which the top glass was removed to prepare the measuring sample. The final form of the measuring sample was as follows: glass/adhesive layer/TAC/hard coat resin layer.

The measuring sample was set on the test stage of the aforementioned micro-indentation hardness tester, and three measurements were performed with the indentation load set to 10 mN, after which the average value was calculated for the indentation depth data.

### (6) Saponification Durability

A 1N KOH solution was heated to 60° C. and the sample film was immersed therein for 2 minutes, after which it was thoroughly washed and dried for saponification treatment. The saponification durability was measured using a scanning probe microscope (SPM) (trade name: High Precision L-trace Large Stage Unit) by SII NanoTechnology Inc., with measurement in AFM mode.

The entire saponified measuring sample film was fixed by attachment to slide glass with NICETACK double-sided tape by Nichiban Co., Ltd., on the base side without the hard coat applied. This was done to flatten the sample, because any risen areas of the sample film can hamper measurement. The measurement was carried out in tapping mode, with a scanning zone of 1 μm×1 μm.

Upon measurement of the saponified sample of Comparative Example 1, sections with loss of the hydrophilic fine particles B were observed after saponification and the anti-sticking property was inferior. On the other hand, measurement of the sample of Example 1 saponified in the same manner showed no observable loss of the hydrophilic fine particles B.

### BRIEF DESCRIPTION OF THE DRAWINGS

FIG. 1 is a drawing corresponding to a SEM photograph (100,000×) showing an example of a cross-section of a hard coat film according to the invention as well as the manner where the hydrophilic fine particles B have formed aggregates in the hard coat layer. The hydrophilic fine particles B appear to be protruding from the surface, but are covered by the matrix components, e.g. the resin C in the figure.

FIG. 2 is a drawing showing the basic layer structure of a hard coat film according to the invention.

FIG. 3 is a schematic diagram showing a hard coat film according to the invention wound up into a long roll.

FIG. 4 is a drawing corresponding to an image of the surface of a hard coat film according to the invention, as observed with a non-contact three-dimensional surface shape and roughness analyzer.

FIG. 5 is a drawing showing the spectrum analysis obtained with a non-contact three-dimensional surface shape and roughness analyzer, as an example of measuring the heights of raised sections and the spacings between raised sections, that have been formed in the surface of a hard coat film according to the invention.

FIG. 6 is a drawing corresponding to a perspective plot representing the irregular shape formed on the surface of a hard coat film according to the invention.

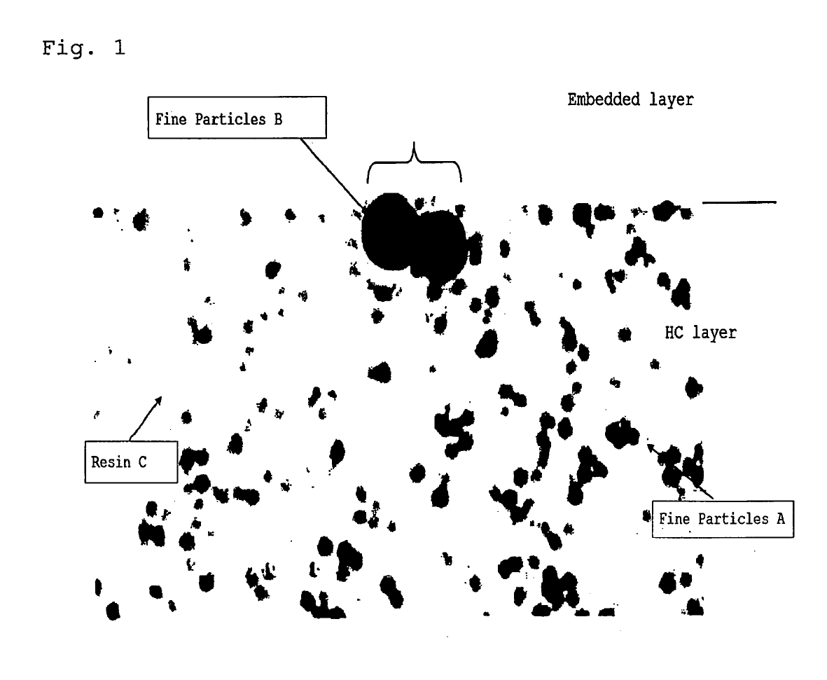

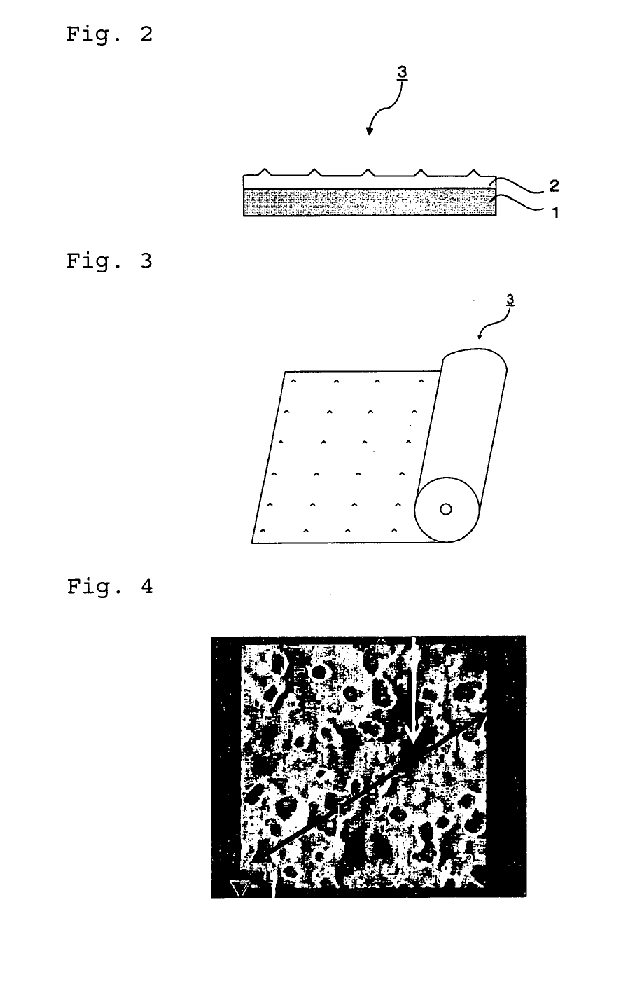

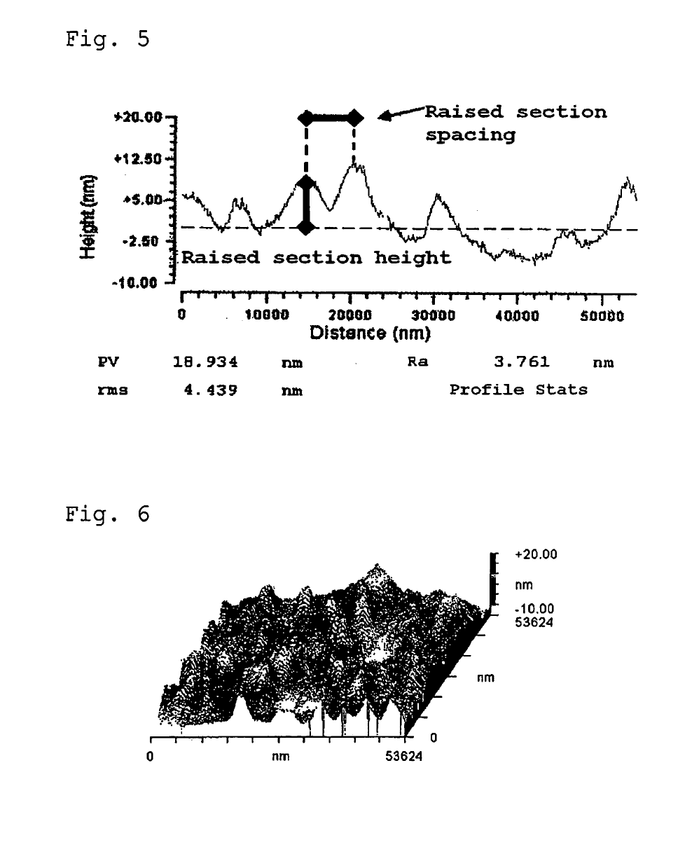

### EXPLANATION OF SYMBOLS

1 Transparent base film
2 Hard coat layer
3 Hard coat film

1-12. (canceled)

13. A hard coat film comprising:
a transparent base film,
a hard coat layer having a surface or an interface and composed of a cured product of a curable resin composition formed on the transparent base film, and
optionally, one or more resin layer(s) laminated over the hard coat layer,
wherein the curable resin composition comprises at least a first type of fine particles B and a second type of fine particles A; and
wherein, when a section of the hard coat film is observed under a scanning electron microscope (SEM) after curing, the first type of fine particles B are present on the surface of the hard coat layer or on the interface between the hard coat layer and the one or more optional resin layer(s), the second type of fine particles A are uniformly dispersed in the hard coat layer, and irregularities are formed on the surface or at the interface.

14. The hard coat film according to claim 13, wherein the irregularities comprise raised sections having a height of from 3 nm to 50 nm.

15. The hard coat film according to claim 14, wherein the raised sections have spacings between the raised sections of 50 nm to 5 μm.

16. The hard coat film according to claim 13, wherein the irregularities comprise raised sections having a height of from 3 nm to 50 nm, and the raised sections have spacings between the raised sections of 50 nm to 5 μm.

17. The hard coat film according to claim 13, wherein the first type of fine particles B protrude, as discrete fine particles or as a double aggregate of the fine particles, from the surface or the interface to form raised sections of the irregularities.

18. The hard coat film according to claim 17, wherein the curable resin composition further comprises a binder, and the binder covers the first type of fine particles B protruding from the surface or the interface.

19. The hard coat film according to claim 13, wherein the second type of fine particles A are inorganic fine particles, and the first type of fine particles B are organic or inorganic fine particles and are roughly or truly spherical fine particles.

20. The hard coat film according to claim 19, wherein the inorganic fine particles are selected from the group consisting of silica fine particles, aluminum oxide fine particles, zirconia fine particles, titania fine particles, zinc oxide fine particles, germanium oxide fine particles, indium oxide fine particles, tin oxide fine particles, indium tin oxide fine particles, antimony oxide fine particles and cerium oxide fine particles.

21. The hard coat film according to claim 19, wherein the spherical fine particles are silica fine particles or alumina fine particles.

22. The hard coat film according to claim 19, wherein the spherical fine particles are polymer fine particles.
